(19) United States
(12) Patent Application Publication
(10) Pub. No.: US 2021/0203177 A1
(43) Pub. Date: Jul. 1, 2021

(54) VEHICLE CHARGING SCHEDULER

(71) Applicant: NIO USA, Inc., San Jose, CA (US)

(72) Inventor: James Peng, La Habra, CA (US)

(21) Appl. No.: 16/731,498

(22) Filed: Dec. 31, 2019

(51) Int. Cl. H02J 7/00; B60L 53/63; B60L 53/64

(52) U.S. Cl. CPC H02J 7/0071; B60L 53/64; B60L 53/63; H02J 7/0048

(57) ABSTRACT

Methods, systems, and devices of a charging scheduler are provided for a vehicle that generates a charging schedule based on home power usage, user charging preferences, user schedule, vehicle information, and/or power provider attributes. The charging scheduler allows a user of a vehicle to connect the vehicle to a charging station and for the charging station to charge the rechargeable energy storage of the vehicle during charging time periods specified in the charging schedule without further user interaction. According to one embodiment, the charging scheduler may use power provider attributes for power costs per time of day and/or for home power usage costs to reduce the cost of charging the rechargeable energy storage of the vehicle. The power provider attributes may be updated in real time, and the charging scheduler may update the charging schedule based on changes to power provider attributes.

### FIELD

The present disclosure is generally directed to vehicle systems, in particular, toward charging of electric, rechargeable electric, and/or hybrid-electric vehicles.

### BACKGROUND

In recent years, transportation methods have changed substantially. This change is due in part to a concern over the limited availability of natural resources, a proliferation in personal technology, and a societal shift to adopt more environmentally friendly transportation solutions. These considerations have encouraged the development of a number of new flexible-fuel vehicles, hybrid-electric vehicles, and electric vehicles.

While these vehicles appear to be new, they are generally implemented as a number of traditional subsystems that are merely tied to an alternative power source. In fact, the design and construction of the vehicles is limited to standard frame sizes, shapes, materials, and transportation concepts. Among other things, these limitations fail to take advantage of the benefits of new technology, power sources, and support infrastructure.

### BRIEF DESCRIPTION OF THE DRAWINGS

FIG. 1 shows a vehicle in accordance with embodiments of the present disclosure;

FIG. 2 shows a plan view of the vehicle in accordance with at least some embodiments of the present disclosure;

FIG. 3 shows a plan view of the vehicle in accordance with embodiments of the present disclosure;

FIG. 4 shows an embodiment of the instrument panel of the vehicle according to one embodiment of the present disclosure;

FIG. 5 is a block diagram of an embodiment of an electrical system of the vehicle;

FIG. 6 is a block diagram of an embodiment of a power generation unit associated with the electrical system of the vehicle;

FIG. 7 is a block diagram of an embodiment of a power storage component associated with the electrical system of the vehicle;

FIG. 8 is a block diagram of an embodiment of loads associated with the electrical system of the vehicle;

FIG. 9 is a block diagram of an embodiment of a communications subsystem of the vehicle;

FIG. 10 is a block diagram of a computing environment associated with the embodiments presented herein;

FIG. 11 is a block diagram of a computing device associated with one or more components described herein;

FIG. 12 is a block diagram of a charging environment for the vehicle in accordance with embodiments of the present disclosure;

FIG. 13 is a block diagram of an energy management system and sensors in accordance with at least some embodiments of the present disclosure;

FIG. 14 is a block diagram illustrating components of a system for determining a charging schedule according to one embodiment of the present disclosure;

FIG. 15 depicts an instrument panel of the vehicle that presents various possible types of information related to the vehicle, power source state of health, or power source state of charge in accordance with at least some embodiments of the present disclosure;

FIG. 16 is a flowchart illustrating a method for creating the vehicle charging schedule according to a further embodiment of the present disclosure; and

FIG. 17 is a flowchart illustrating a method for updating the vehicle charging schedule according to a further embodiment of the present disclosure.

### DETAILED DESCRIPTION

Embodiments of the present disclosure will be described in connection with a vehicle, and in some embodiments, an electric vehicle, rechargeable electric vehicle, and/or hybrid-electric vehicle and associated systems.

In some embodiments, a vehicle charging scheduler is provided that schedules charging of an electric or hybrid vehicle during periods of lower energy use in the power grid, such as during off-peak hours when energy costs are lower. As will be appreciated, in Time-of-Use plans of providers or sellers of power (e.g., electric utility, mains electricity, etc.) electricity rates per kilowatt-hour vary according to peak and off-peak times. During peak-use times, higher consumer demand increases the cost to deliver and generate electricity. In Time-of-Use plans, utilities pass these fluctuations onto the consumer within consumer delivery charges. Peak and off-peak rates can vary significantly based on hourly and even seasonal changes in demand. When consumers in a common service area ail want to use electricity at the same time, the service provider tries to incentivize consumers to shift their use to off-peak periods. Some service providers even have “super-peak”, “partial-peak”, or “mid-peak” times. What are off-peak and peak times and the corresponding charges can be obtained a website of the service provider.

The charging scheduler can be implemented in a number of ways. For example, the charging scheduler can be a user interface controller accessible via a user interface of the vehicle, a communication device of the owner that is discrete from the vehicle, or a user interface on the charger itself. In some embodiments, the user interface controller can provide a display enabling the operator to schedule when and how much charging will occur (e.g., a slower rate of charging can be used during peak hours and a higher rate of charging can be used during off-peak hours). In some embodiments, the charging scheduler is implemented as an intelligent assistant, such as Google™, Alexa™, Siri™, and the like. For example, the operator or user plugs in the charger to an outlet and says to the home system “Hey Alexa, start charging my car at earliest time of off-peak charging time.” In some embodiments, the user preconfigures his or her preferences in the charging scheduler and the charging scheduler automatically configures a charging plan based on the user's preferences (e.g., charging cost requirements, etc.), scheduled calendar activities, historical driving behavior, and the like. The charging plan, for instance, can specify discrete time intervals for charging and a corresponding rate of charging for each time interval. In some embodiment6s, the charging scheduler requests the user to approve the charging plan before implementation. In some embodiments, the charging scheduler dynamically charges the vehicle based on current utility rates and local energy usage associated with the user, such as energy usage within the user's home. This advantageously enables the user not only to keep overall utility usage rates at lower levels but also to avoid power interruptions within times of high-power usage, such as due to flipped or tripped circuit box breakers.

By way of example, the charging scheduler senses, as a starting condition, that a charging unit of the vehicle has been connected with the grid, such as via a plug-in charger. In response, the charging scheduler displays to the user a cheapest charging time starting at a first time (e.g., 11 am), asks the user to confirm that charging will begin at the first time or a different customizable time, and, depending on user commands, commences charging at the first time or a different time specified by the user. The charging scheduler can further ask the user to specify an ending condition, such as charge until battery full, only end when unplug, charge until end of off-peak period (e.g., 6:59 am), charge for specified duration (e.g., 3 hours), and the like. In another example, the charging scheduler is configured as an artificially intelligent assistant in a smart home system that asks the user if they would like to charge until the battery is full. If so, the charging scheduler changes rechargeable energy storage until full. If not, the charging scheduler asks the user if they would like to charge until the end of an off-peak period or alternatively specify a specific duration. In another example, the charging scheduler is configured as an artificially intelligent assistant in a smart home system that asks the user if he would like to start charging the vehicle at an earliest time of off-peak charging or a customized time and, depending on the user response commences charging at the earliest off-peak time or the customized time.

The charging scheduler is particularly useful with a smart grid. A smart grid is an electrical grid which includes a variety of operation and energy measures including smart meters, smart appliances, renewable energy resources, and energy efficient resources. A smart grid may warn charging schedulers to reduce the load temporarily (to allow time to start up a larger generator) or continuously (in the case of limited resources). Using mathematical prediction algorithms, the smart grid can predict how many standby generators need to be used, to reach a certain failure rate. In the traditional grid, the failure rate can only be reduced at the cost of more standby generators. In a smart grid, the load reduction by even a small portion of the clients may eliminate the problem. To reduce demand during the high cost peak usage periods, communications and metering technologies can inform the charging scheduler when energy demand is high to prevent system overloads.

In some embodiments, the provider or seller of a power (e.g., electric utility, mains electricity, etc.) offered to a user or owner of a vehicle that requires charging of the rechargeable energy storage of the vehicle sets fees based on business rules defining a pricing model or structure and applying those rules based on certain conditions to create power provider attributes. For example, a power provider attribute for charging a vehicle may define the fee higher during certain peak times such as high-power usage periods, e.g., 2:00 pm-8:00 pm, and define the fee lower during off peak hours, e.g., 11:00 pm-7:00 am. Another attribute may additionally or alternatively define a higher fee based on the total power consumed at a household during a time period, e.g., 1 kWh during a one-hour time period. For example, charging two vehicles or fast charging one vehicle during the same time period may result in a higher fee due to the total power consumed exceeding a threshold during the charging period.

Additionally or alternatively, the power provider attributes may consider certain conditions related to a particular vehicle or user. Such conditions can influence application of the rules to provide individual vehicle or user-specific pricing. Since leaving the vehicle on a charger beyond the time when the battery is fully or adequately charged needlessly consumes electricity, an effective pricing model could charge users more for charging longer, and possibly less or crediting users for charging for a shorter time period.

While the disclosure is directed to a vehicle, such as a truck, car, motorcycles, or other powered wheeled or tracked vehicle, the concepts of the disclosure can apply to other types of vehicles, including, without limitation, ships, boats, aircraft (e.g., unmanned aerial vehicles and drones), and/or the like.

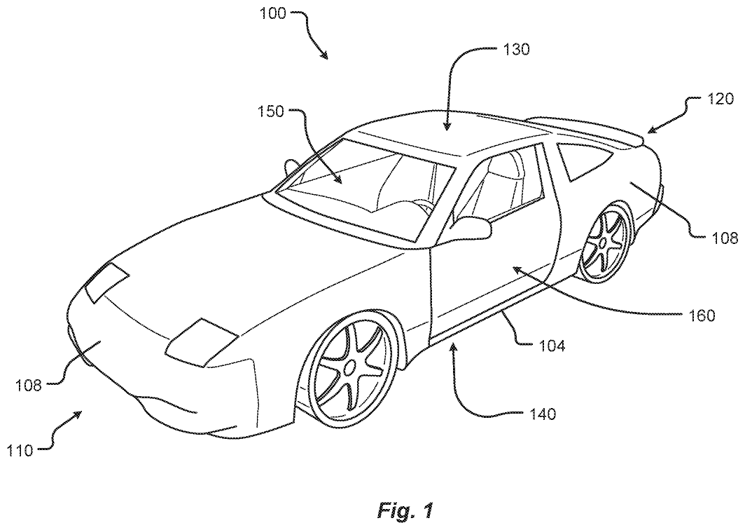

FIG. 1 shows a perspective view of a vehicle 100 in accordance with embodiments of the present disclosure. The electric vehicle 100 comprises a vehicle front 110, vehicle aft or rear 120, vehicle roof 130, at least one vehicle side 160, a vehicle undercarriage 140, and a vehicle interior 150. In any event, the vehicle 100 may include a frame 104 and one or more body panels 108 mounted or affixed thereto. The vehicle 100 may include one or more interior components (e.g., components inside an interior space 150, or user space, of a vehicle 100, etc.), exterior components (e.g., components outside of the interior space 150, or user space, of a vehicle 100, etc.), drive systems, controls systems, structural components, etc.

Although shown in the form of a car, it should be appreciated that the vehicle 100 described herein may include any conveyance or model of a conveyance, where the conveyance was designed for the purpose of moving one or more tangible objects, such as people, animals, cargo, and the like. The term “vehicle” does not require that a conveyance moves or is capable of movement. Typical vehicles may include but are in no way limited to cars, trucks, motorcycles, busses, automobiles, trains, railed conveyances, boats, ships, marine conveyances, submarine conveyances, airplanes, space craft, flying machines, human-powered conveyances, and the like.

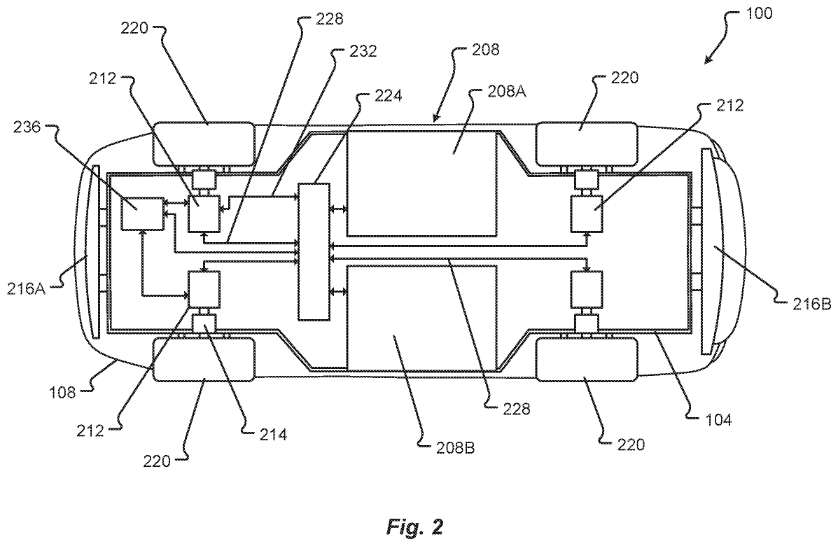

Referring now to FIG. 2, a plan view of the vehicle 100 will be described in accordance with at least some embodiments of the present disclosure. As provided above, the vehicle 100 may comprise a number of electrical and/or mechanical systems, subsystems, etc. The mechanical systems of the vehicle 100 can include structural, power, safety, and communications subsystems, to name a few. While each subsystem may be described separately, it should be appreciated that the components of a particular subsystem may be shared between one or more other subsystems of the vehicle 100.

The structural subsystem includes the frame 104 of the vehicle 100. The frame 104 may comprise a separate frame and body construction (i.e., body-on-frame construction), a unitary frame and body construction (i.e., a unibody construction), or any other construction defining the structure of the vehicle 100. The frame 104 may be made from one or more materials including, but in no way limited to steel, titanium, aluminum, carbon fiber, plastic, polymers, etc., and/or combinations thereof. In some embodiments, the frame 104 may be formed, welded, fused, fastened, pressed, etc., combinations thereof, or otherwise shaped to define a physical structure and strength of the vehicle 100. In any event, the frame 104 may comprise one or more surfaces, connections, protrusions, cavities, mounting points, tabs, slots, or other features that are configured to receive other components that make up the vehicle 100. For example, the body panels 108, powertrain subsystem, controls systems, interior components, communications subsystem, and safety subsystem may interconnect with, or attach to, the frame 104 of the vehicle 100.

The frame 104 may include one or more modular system and/or subsystem connection mechanisms. These mechanisms may include features that are configured to provide a selectively interchangeable interface for one or more of the systems and/or subsystems described herein. The mechanisms may provide for a quick exchange, or swapping, of components while providing enhanced security and adaptability over conventional manufacturing or attachment. For instance, the ability to selectively interchange systems and/or subsystems in the vehicle 100 allow the vehicle 100 to adapt to the ever-changing technological demands of society and advances in safety. Among other things, the mechanisms may provide for the quick exchange of batteries, capacitors, power sources 208A, 208B, motors 212, engines, safety equipment, controllers, user interfaces, interiors exterior components, body panels 108, bumpers 216, sensors, etc., and/or combinations thereof. Additionally, or alternatively, the mechanisms may provide unique security hardware and/or software embedded therein that, among other things, can prevent fraudulent or low-quality construction replacements from being used in the vehicle 100. Similarly, the mechanisms, subsystems, and/or receiving features in the vehicle 100 may employ poka-yoke, or mistake-proofing, features that ensure a particular mechanism is always interconnected with the vehicle 100 in a correct position, function, etc.

By way of example, complete systems or subsystems may be removed and/or replaced from a vehicle 100 utilizing a single-minute exchange (SME) principle. In some embodiments, the frame 104 may include slides, receptacles, cavities, protrusions, and/or a number of other features that allow for quick exchange of system components. In one embodiment, the frame 104 may include tray or ledge features, mechanical interconnection features, locking mechanisms, retaining mechanisms, etc., and/or combinations thereof. In some embodiments, it may be beneficial to quickly remove a used power source 208A, 208B (e.g., battery unit, capacitor unit, etc.) from the vehicle 100 and replace the used power source 208A, 208B with a charged or new power source. Continuing this example, the power source 208A, 208B may include selectively interchangeable features that interconnect with the frame 104 or other portion of the vehicle 100. For instance, in a power source 208A, 208B replacement, the quick release features may be configured to release the power source 208A, 208B from an engaged position and slide or move in a direction away from the frame 104 of a vehicle 100. Once removed, or separated from, the vehicle, the power source 208A, 208B may be replaced (e.g., with a new power source, a charged power source, etc.) by engaging the replacement power source into a system receiving position adjacent to the vehicle 100. In some embodiments, the vehicle 100 may include one or more actuators configured to position, lift, slide, or otherwise engage the replacement power source with the vehicle 100. In one embodiment, the replacement power source may be inserted into the vehicle 100 or vehicle frame 104 with mechanisms and/or machines that are external and/or separate from the vehicle 100.

In some embodiments, the frame 104 may include one or more features configured to selectively interconnect with other vehicles and/or portions of vehicles. These selectively interconnecting features can allow for one or more vehicles to selectively couple together and decouple for a variety of purposes. For example, it is an aspect of the present disclosure that a number of vehicles may be selectively coupled together to share energy, increase power output, provide security, decrease power consumption, provide towing services, and/or provide a range of other benefits. Continuing this example, the vehicles may be coupled together based on travel route, destination, preferences, settings, sensor information, and/or some other data. The coupling may be initiated by at least one controller of the vehicle and/or traffic control system upon determining that a coupling is beneficial to one or more vehicles in a group of vehicles or a traffic system. As can be appreciated, the power consumption for a group of vehicles traveling in a same direction may be reduced or decreased by removing any aerodynamic separation between vehicles. In this case, the vehicles may be coupled together to subject only the foremost vehicle in the coupling to air and/or wind resistance during travel. In one embodiment, the power output by the group of vehicles may be proportionally or selectively controlled to provide a specific output from each of the one or more of the vehicles in the group.

The interconnecting, or coupling, features may be configured as electromagnetic mechanisms, mechanical couplings, electromechanical coupling mechanisms, etc., and/or combinations thereof. The features may be selectively deployed from a portion of the frame 104 and/or body of the vehicle 100. In some cases, the features may be built into the frame 104 and/or body of the vehicle 100. In any event, the features may deploy from an unexposed position to an exposed position or may be configured to selectively engage/disengage without requiring an exposure or deployment of the mechanism from the frame 104 and/or body of the vehicle 100. In some embodiments, the interconnecting features may be configured to interconnect one or more of power, communications, electrical energy, fuel, and/or the like. One or more of the power, mechanical, and/or communications connections between vehicles may be part of a single interconnection mechanism. In some embodiments, the interconnection mechanism may include multiple connection mechanisms. In any event, the single interconnection mechanism or the interconnection mechanism may employ the poka-yoke features as described above.

The power system of the vehicle 100 may include the powertrain, power distribution system, accessory power system, and/or any other components that store power, provide power, convert power, and/or distribute power to one or more portions of the vehicle 100. The powertrain may include the one or more electric motors 212 of the vehicle 100. The electric motors 212 are configured to convert electrical energy provided by a power source into mechanical energy. This mechanical energy may be in the form of a rotational or other output force that is configured to propel or otherwise provide a motive force for the vehicle 100.

In some embodiments, the vehicle 100 may include one or more drive wheels 220 that are driven by the one or more electric motors 212 and motor controllers 214. In some cases, the vehicle 100 may include an electric motor 212 configured to provide a driving force for each drive wheel 220. In other cases, a single electric motor 212 may be configured to share an output force between two or more drive wheels 220 via one or more power transmission components. It is an aspect of the present disclosure that the powertrain may include one or more power transmission components, motor controllers 214, and/or power controllers that can provide a controlled output of power to one or more of the drive wheels 220 of the vehicle 100. The power transmission components, power controllers, or motor controllers 214 may be controlled by at least one other vehicle controller or computer system as described herein.

As provided above, the powertrain of the vehicle 100 may include one or more power sources 208A, 208B. These one or more power sources 208A, 208B may be configured to provide drive power, system and/or subsystem power, accessory power, etc. While described herein as a single power source 208 for sake of clarity, embodiments of the present disclosure are not so limited. For example, it should be appreciated that independent, different, or separate power sources 208A, 208B may provide power to various systems of the vehicle 100. For instance, a drive power source may be configured to provide the power for the one or more electric motors 212 of the vehicle 100, while a system power source may be configured to provide the power for one or more other systems and/or subsystems of the vehicle 100. Other power sources may include an accessory power source, a backup power source, a critical system power source, and/or other separate power sources. Separating the power sources 208A, 208B in this manner may provide a number of benefits over conventional vehicle systems. For example, separating the power sources 208A, 208B allow one power source 208 to be removed and/or replaced independently without requiring that power be removed from all systems and/or subsystems of the vehicle 100 during a power source 208 removal/replacement. For instance, one or more of the accessories, communications, safety equipment, and/or backup power systems, etc., may be maintained even when a particular power source 208A, 208B is depleted, removed, or becomes otherwise inoperable.

In some embodiments, the drive power source may be separated into two or more cells, units, sources, and/or systems. By way of example, a vehicle 100 may include a first drive power source 208A and a second drive power source 208B. The first drive power source 208A may be operated independently from or in conjunction with the second drive power source 208B and vice versa. Continuing this example, the first drive power source 208A may be removed from a vehicle while a second drive power source 208B can be maintained in the vehicle 100 to provide drive power. This approach allows the vehicle 100 to significantly reduce weight (e.g., of the first drive power source 208A, etc.) and improve power consumption, even if only for a temporary period of time. In some cases, a vehicle 100 running low on power may automatically determine that pulling over to a rest area, emergency lane, and removing, or “dropping off,” at least one power source 208A, 208B may reduce enough weight of the vehicle 100 to allow the vehicle 100 to navigate to the closest power source replacement and/or charging area. In some embodiments, the removed, or “dropped off,” power source 208A may be collected by a collection service, vehicle mechanic, tow truck, or even another vehicle or individual.

The power source 208 may include a GPS or other geographical location system that may be configured to emit a location signal to one or more receiving entities. For instance, the signal may be broadcast or targeted to a specific receiving party. Additionally, or alternatively, the power source 208 may include a unique identifier that may be used to associate the power source 208 with a particular vehicle 100 or vehicle user. This unique identifier may allow an efficient recovery of the power source 208 dropped off. In some embodiments, the unique identifier may provide information for the particular vehicle 100 or vehicle user to be billed or charged with a cost of recovery for the power source 208.

The power source 208 may include a charge controller 224 that may be configured to determine charge levels of the power source 208, control a rate at which charge is drawn from the power source 208, control a rate at which charge is added to the power source 208, and/or monitor a health of the power source 208 (e.g., one or more cells, portions, etc.). In some embodiments, the charge controller 224 or the power source 208 may include a communication interface. The communication interface can allow the charge controller 224 to report a state of the power source 208 to one or more other controllers of the vehicle 100 or even communicate with a communication device separate and/or apart from the vehicle 100. Additionally, or alternatively, the communication interface may be configured to receive instructions (e.g., control instructions, charge instructions, communication instructions, etc.) from one or more other controllers or computers of the vehicle 100 or a communication device that is separate and/or apart from the vehicle 100.

The powertrain includes one or more power distribution systems configured to transmit power from the power source 208 to one or more electric motors 212 in the vehicle 100. The power distribution system may include electrical interconnections 228 in the form of cables, wires, traces, wireless power transmission systems, etc., and/or combinations thereof. It is an aspect of the present disclosure that the vehicle 100 include one or more redundant electrical interconnections 232 of the power distribution system. The redundant electrical interconnections 232 can allow power to be distributed to one or more systems and/or subsystems of the vehicle 100 even in the event of a failure of an electrical interconnection portion of the vehicle 100 (e.g., due to an accident, mishap, tampering, or other harm to a particular electrical interconnection, etc.). In some embodiments, a user of a vehicle 100 may be alerted via a user interface associated with the vehicle 100 that a redundant electrical interconnection 232 is being used and/or damage has occurred to a particular area of the vehicle electrical system. In any event, the one or more redundant electrical interconnections 232 may be configured along completely different routes than the electrical interconnections 228 and/or include different modes of failure than the electrical interconnections 228 to, among other things, prevent a total interruption power distribution in the event of a failure.

In some embodiments, the power distribution system may include an energy recovery system 236. This energy recovery system 236, or kinetic energy recovery system, may be configured to recover energy produced by the movement of a vehicle 100. The recovered energy may be stored as electrical and/or mechanical energy. For instance, as a vehicle 100 travels or moves, a certain amount of energy is required to accelerate, maintain a speed, stop, or slow the vehicle 100. In any event, a moving vehicle has a certain amount of kinetic energy. When brakes are applied in a typical moving vehicle, most of the kinetic energy of the vehicle is lost as the generation of heat in the braking mechanism. In an energy recovery system 236, when a vehicle 100 brakes, at least a portion of the kinetic energy is converted into electrical and/or mechanical energy for storage. Mechanical energy may be stored as mechanical movement (e.g., in a flywheel, etc.) and electrical energy may be stored in batteries, capacitors, and/or some other electrical storage system. In some embodiments, electrical energy recovered may be stored in the power source 208. For example, the recovered electrical energy may be used to charge the power source 208 of the vehicle 100.

The vehicle 100 may include one or more safety systems. Vehicle safety systems can include a variety of mechanical and/or electrical components including, but in no way limited to, low impact or energy-absorbing bumpers 216A, 216B, crumple zones, reinforced body panels, reinforced frame components, impact bars, power source containment zones, safety glass, seatbelts, supplemental restraint systems, air bags, escape hatches, removable access panels, impact sensors, accelerometers, vision systems, radar systems, etc., and/or the like. In some embodiments, the one or more of the safety components may include a safety sensor or group of safety sensors associated with the one or more of the safety components. For example, a crumple zone may include one or more strain gages, impact sensors, pressure transducers, etc. These sensors may be configured to detect or determine whether a portion of the vehicle 100 has been subjected to a particular force, deformation, or other impact. Once detected, the information collected by the sensors may be transmitted or sent to one or more of a controller of the vehicle 100 (e.g., a safety controller, vehicle controller, etc.) or a communication device associated with the vehicle 100 (e.g., across a communication network, etc.).

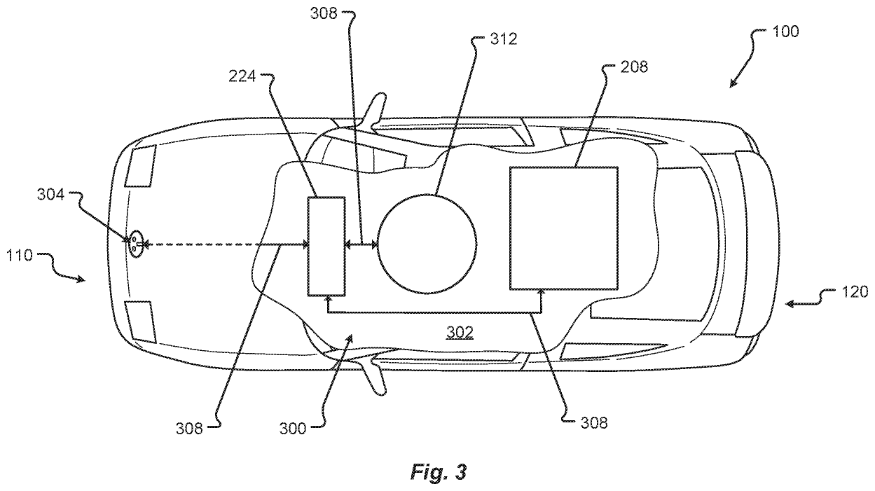

FIG. 3 shows a plan view of the vehicle 100 in accordance with embodiments of the present disclosure. In particular, FIG. 3 shows a broken section 302 of a charging system 300 for the vehicle 100. The charging system 300 may include a plug or receptacle 304 configured to receive power from an external power source (e.g., a source of power that is external to and/or separate from the vehicle 100, etc.). An example of an external power source may include the standard industrial, commercial, or residential power that is provided across power lines, commonly called mains electricity. Another example of an external power source may include a proprietary power system configured to provide power to the vehicle 100. In any event, power received at the plug/receptacle 304 may be transferred via at least one power transmission interconnection 308. Similar, if not identical, to the electrical interconnections 228 described above, the at least one power transmission interconnection 308 may be one or more cables, wires, traces, wireless power transmission systems, etc., and/or combinations thereof. Electrical energy in the form of charge can be transferred from the external power source to the charge controller 224. As provided above, the charge controller 224 may regulate the addition of charge to at least one power source 208 of the vehicle 100 (e.g., until the at least one power source 208 is full or at a capacity, etc.).

In some embodiments, the vehicle 100 may include an inductive charging system and inductive charger 312. The inductive charger 312 may be configured to receive electrical energy from an inductive power source external to the vehicle 100. In one embodiment, when the vehicle 100 and/or the inductive charger 312 is positioned over an inductive power source external to the vehicle 100, electrical energy can be transferred from the inductive power source to the vehicle 100. For example, the inductive charger 312 may receive the charge and transfer the charge via at least one power transmission interconnection 308 to the charge controller 324 and/or the power source 208 of the vehicle 100. The inductive charger 312 may be concealed in a portion of the vehicle 100 (e.g., at least partially protected by the frame 104, one or more body panels 108, a shroud, a shield, a protective cover, etc., and/or combinations thereof) and/or may be deployed from the vehicle 100. In some embodiments, the inductive charger 312 may be configured to receive charge only when the inductive charger 312 is deployed from the vehicle 100. In other embodiments, the inductive charger 312 may be configured to receive charge while concealed in the portion of the vehicle 100.

In addition to the mechanical components described herein, the vehicle 100 may include a number of user interface devices. The user interface devices receive and translate human input into a mechanical movement or electrical signal or stimulus. The human input may be one or more of motion (e.g., body movement, body part movement, in two-dimensional or three-dimensional space, etc.), voice, touch, and/or physical interaction with the components of the vehicle 100. In some embodiments, the human input may be configured to control one or more functions of the vehicle 100 and/or systems of the vehicle 100 described herein. User interfaces may include, but are in no way limited to, at least one graphical user interface of a display device, steering wheel or mechanism, transmission lever or button (e.g., including park, neutral, reverse, and/or drive positions, etc.), throttle control pedal or mechanism, brake control pedal or mechanism, power control switch, communications equipment, etc.

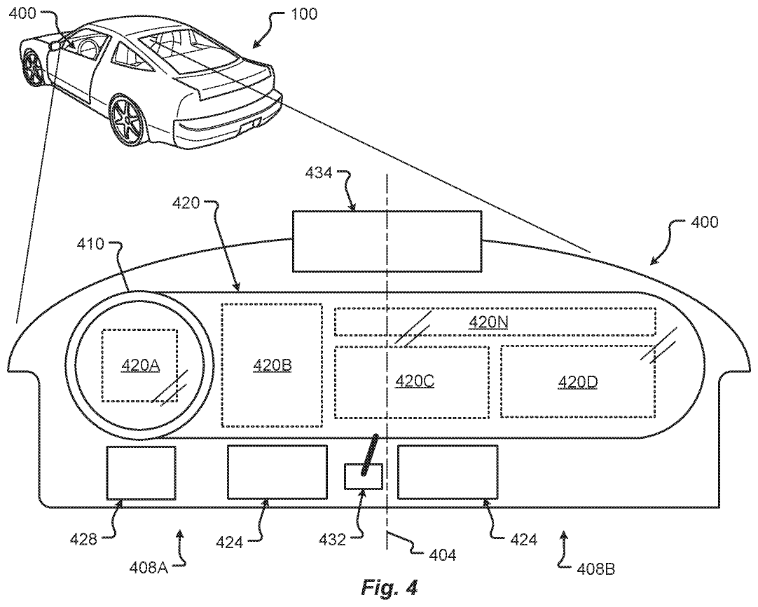

FIG. 4 shows one embodiment of the instrument panel 400 of the vehicle 100. The instrument panel 400 of vehicle 100 comprises a steering wheel 410, a vehicle operational display 420 (e.g., configured to present and/or display driving data such as speed, measured air resistance, vehicle information, entertainment information, etc.), one or more auxiliary displays 424 (e.g., configured to present and/or display information segregated from the operational display 420, entertainment applications, movies, music, etc.), a heads-up display 434 (e.g., configured to display any information previously described including, but in no way limited to, guidance information such as route to destination, or obstacle warning information to warn of a potential collision, or some or all primary vehicle operational data such as speed, resistance, etc.), a power management display 428 (e.g., configured to display data corresponding to electric power levels of vehicle 100, reserve power, charging status, etc.), and an input device 432 (e.g., a controller, touchscreen, or other interface device configured to interface with one or more displays in the instrument panel or components of the vehicle 100. The input device 432 may be configured as a joystick, mouse, touchpad, tablet, 3D gesture capture device, etc.). In some embodiments, the input device 432 may be used to manually maneuver a portion of the vehicle 100 into a charging position (e.g., moving a charging plate to a desired separation distance, etc.).

While one or more of displays of instrument panel 400 may be touch-screen displays, it should be appreciated that the vehicle operational display may be a display incapable of receiving touch input. For instance, the operational display 420 that spans across an interior space centerline 404 and across both a first zone 408A and a second zone 408B may be isolated from receiving input from touch, especially from a passenger. In some cases, a display that provides vehicle operation or critical systems information and interface may be restricted from receiving touch input and/or be configured as a non-touch display. This type of configuration can prevent dangerous mistakes in providing touch input where such input may cause an accident or unwanted control.

In some embodiments, one or more displays of the instrument panel 400 may be mobile devices and/or applications residing on a mobile device such as a smart phone. Additionally, or alternatively, any of the information described herein may be presented to one or more portions 420A-N of the operational display 420 or other display 424, 428, 434. In one embodiment, one or more displays of the instrument panel 400 may be physically separated or detached from the instrument panel 400. In some cases, a detachable display may remain tethered to the instrument panel.

The portions 420A-N of the operational display 420 may be dynamically reconfigured and/or resized to suit any display of information as described. Additionally, or alternatively, the number of portions 420A-N used to visually present information via the operational display 420 may be dynamically increased or decreased as required and are not limited to the configurations shown.

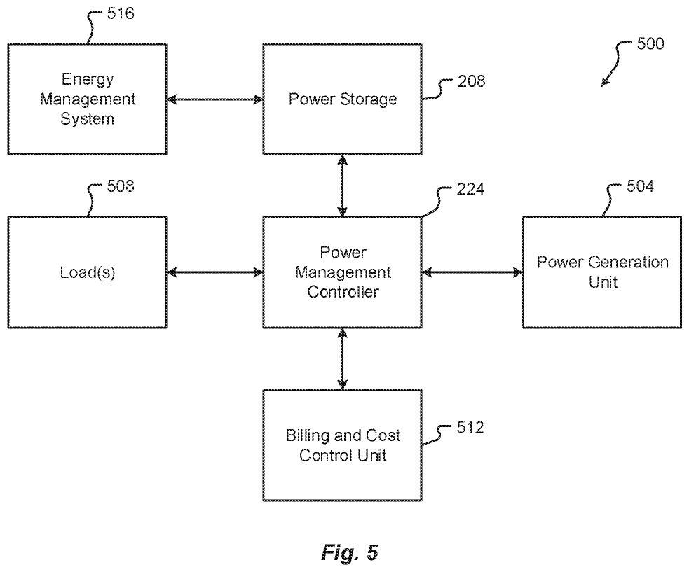

An embodiment of the electrical system 500 associated with the vehicle 100 may be as shown in FIG. 5. The electrical system 500 can include power source(s) that generate power, power storage that stores power, and/or load(s) that consume power. Power sources may be associated with a power generation unit 504. Power storage may be associated with a power storage system 208. Loads may be associated with loads 508. The electrical system 500 may be managed by a power management controller 224. Further, the electrical system 500 can include one or more other interfaces or controllers, which can include the billing and cost control unit 512.

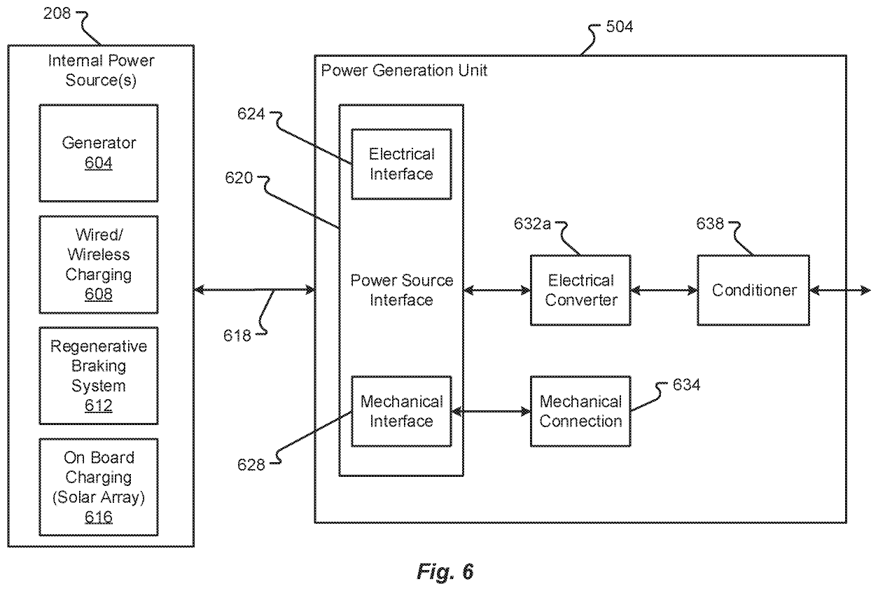

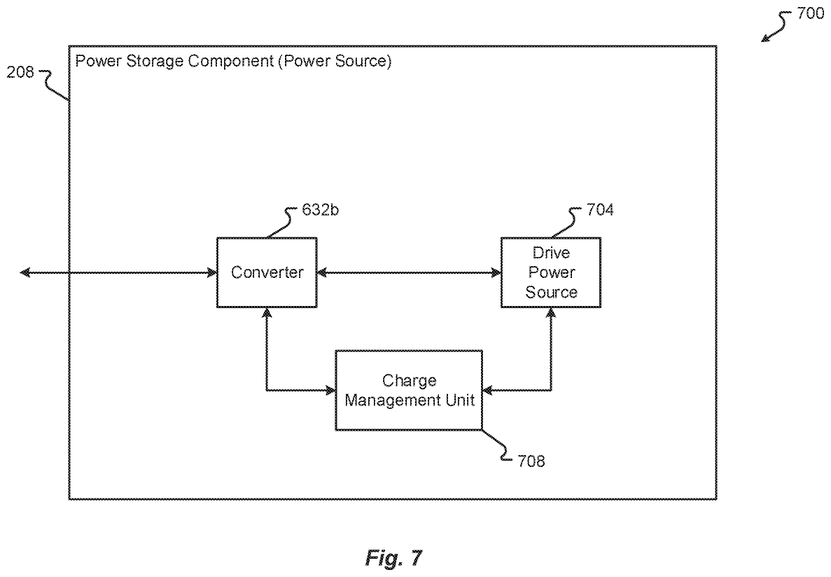

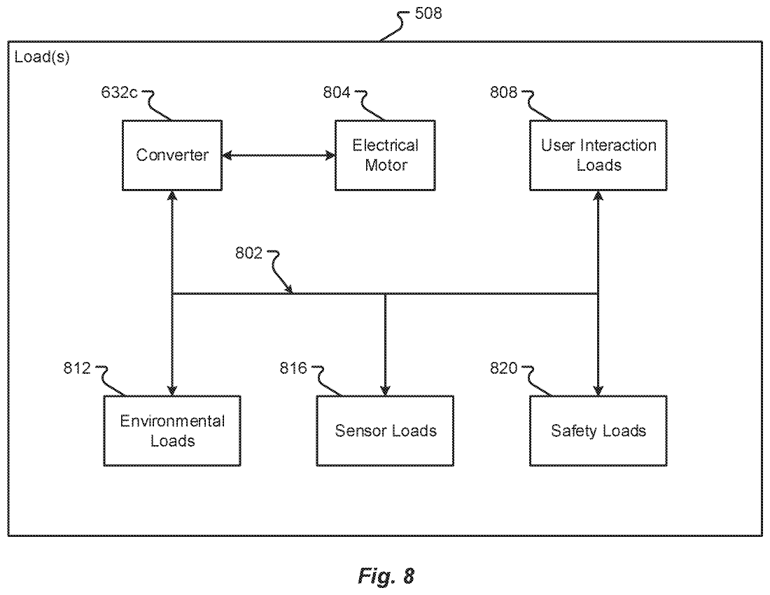

The power generation unit 504 may be as described in conjunction with FIG. 6. The power storage component 208 may be as described in conjunction with FIG. 7. The loads 508 may be as described in conjunction with FIG. 8.

The billing and cost control unit 512 may interface with the power management controller 224 to determine the amount of charge or power provided to the power storage component 208 through the power generation unit 504. The billing and cost control unit 512 can then provide information for billing the vehicle owner. Thus, the billing and cost control unit 512 can receive and/or send power information to third party system(s) regarding the received charge or rate schedule or plan (e.g., the Time-of-Use plans of providers or sellers of power setting forth electricity rates per kilowatt-hour that vary according to peak and off-peak times) from an external source. The information provided can help determine an amount of money required or would be required, from the owner of the vehicle, as payment for the provided power currently or at a selected time in the future. Alternatively, or in addition, if the owner of the vehicle provided power to another vehicle (or another device/system), that owner may be owed compensation for the provided power or energy, e.g., a credit. This is particularly beneficial in smart grid applications.

The power management controller 224 can be a computer or computing system(s) and/or electrical system with associated components, as described herein, capable of managing the power generation unit 504 to receive power, routing the power to the power storage component 208, and then providing the power from either the power generation unit 504 and/or the power storage component 208 to the loads 508. Thus, the power management controller 224 may execute programming that controls switches, devices, components, etc. involved in the reception, storage, and provision of the power in the electrical system 500.

In some embodiments, an energy management system (EMS) 516 is also in communication with or monitoring the utilization of the power storage component 208 (or constituent parts thereof). While depicted as being separate from the power management controller 224, it should be appreciated that the EMS 516 may be incorporated in or provided as part of the power management controller 224. The EMS 516 may be responsible for monitoring power storage component 208 (e.g., battery cells, modules, packs, or the like) in an effort to determine both the state of charge (SOC) for the power storage component 208 and/or state of health (SOH) for the power storage component 208. The EMS 516 may further monitor the operational performance of the power storage component 208 (e.g., by monitoring voltage, resistance, capacitance, charge time (also called charge duration), number of charges, charge dissipation, etc.) by accessing one or more sensors. The operational performance information can then be converted into SOC information and SOH information. As will be discussed in further detail herein, the SOC information and SOH information can be reported (in part or entirely) to an operator of the vehicle 100 as well as to other remote servers.

An embodiment of the power generation unit 504 may be as shown in FIG. 6. Generally, the power generation unit 504 may be electrically coupled to one or more power sources 208. The power sources 208 can include power sources internal and/or associated with the vehicle 100 and/or power sources external to the vehicle 100 to which the vehicle 100 electrically connects. One of the internal power sources can include an on-board generator 604. The generator 604 may be an alternating current (AC) generator, a direct current (DC) generator or a self-excited generator. The AC generators can include induction generators, linear electric generators, and/or other types of generators. The DC generators can include homopolar generators and/or other types of generators. The generator 604 can be brushless or include brush contacts and generate the electric field with permanent magnets or through induction. The generator 604 may be mechanically coupled to a source of kinetic energy, such as an axle or some other power take-off. The generator 604 may also have another mechanical coupling to an exterior source of kinetic energy, for example, a wind turbine.

Another power source 208 may include wired or wireless charging 608. The wireless charging system 608 may include inductive and/or resonant frequency inductive charging systems that can include coils, frequency generators, controllers, etc. Wired charging may be any kind of grid-connected charging that has a physical connection, although, the wireless charging may be grid connected through a wireless interface. The wired charging system can include connectors, wired interconnections, the controllers, etc. The wired and wireless charging systems 608 can provide power to the power generation unit 504 from external power sources 208.

Internal sources for power may include a regenerative braking system 612. The regenerative braking system 612 can convert the kinetic energy of the moving car into electrical energy through a generation system mounted within the wheels, axle, and/or braking system of the vehicle 100. The regenerative braking system 612 can include any coils, magnets, electrical interconnections, converters, controllers, etc. required to convert the kinetic energy into electrical energy.

Another source of power 208, internal to or associated with the vehicle 100, may be a solar array 616. The solar array 616 may include any system or device of one or more solar cells mounted on the exterior of the vehicle 100 or integrated within the body panels of the vehicle 100 that provides or converts solar energy into electrical energy to provide to the power generation unit 504.

The power sources 208 may be connected to the power generation unit 504 through an electrical interconnection 618. The electrical interconnection 618 can include any wire, interface, bus, etc. between the one or more power sources 208 and the power generation unit 504.

The power generation unit 504 can also include a power source interface 620. The power source interface 620 can be any type of physical and/or electrical interface used to receive the electrical energy from the one or more power sources 208; thus, the power source interface 620 can include an electrical interface 624 that receives the electrical energy and a mechanical interface 628 which may include wires, connectors, or other types of devices or physical connections. The mechanical interface 608 can also include a physical/electrical connection 634 to the power generation unit 504.

The electrical energy from the power source 208 can be processed through the power source interface 624 to an electric converter 632. The electric converter 632 may convert the characteristics of the power from one of the power sources into a useable form that may be used either by the power storage component 208 or one or more loads 508 within the vehicle 100. The electrical converter 624 may include any electronics or electrical devices and/or component that can change electrical characteristics, e.g., AC frequency, amplitude, phase, etc. associated with the electrical energy provided by the power source 208. The converted electrical energy may then be provided to an optional conditioner 638. The conditioner 638 may include any electronics or electrical devices and/or component that may further condition the converted electrical energy by removing harmonics, noise, etc. from the electrical energy to provide a more stable and effective form of power to the vehicle 100.

An embodiment of the power storage component 208 may be as shown in FIG. 7. The power storage unit can include an electrical converter 632b, one or more batteries, one or more rechargeable batteries, one or more capacitors, one or more accumulators, one or more supercapacitors, one or more ultrabatteries, and/or superconducting magnetics 704 (called the drive power source), and/or a charge management unit 708. The converter 632b may be the same or similar to the electrical converter 632a as shown in FIG. 6. The converter 632b may be a replacement for the electric converter 632a shown in FIG. 6 and thus eliminate the need for the electrical converter 632a as shown in FIG. 6. However, if the electrical converter 632a is provided in the power generation unit 504, the converter 632b, as shown in the power storage unit 208, may be eliminated. The converter 632b can also be redundant or different from the electrical converter 632a as shown in FIG. 6 and may provide a different form of energy to the drive power source 704. Thus, the converter 632b can change the energy characteristics specifically for the drive power source 704.

The drive power source 704 can be any type of battery for storing electrical energy, for example, a lithium ion battery, a lead acid battery, a nickel cadmium battery, etc. Further, the drive power source 704 may include different types of power storage systems, such as, ionic fluids or other types of fuel cell systems. The drive power source 704 may also include one or more high-capacity capacitors. The capacitors may be used for long-term or short-term storage of electrical energy. The input into the capacitor may be different from the output, and thus, the capacitor may be charged quickly but drain slowly. The functioning of the converter 632 and drive power source 704 may be monitored or managed by a charge management unit 708.

The charge management unit 708 can include any hardware (e.g., any electronics or electrical devices and/or components), software, or firmware operable to adjust the operations of the converter 632 or drive power source 704. The charge management unit 708 can receive inputs or periodically monitor the converter 632 and/or drive power source 704 from this information; the charge management unit 708 may then adjust settings or inputs into the converter 632 or drive power source 704 to control the operation of the power storage system 208.

In some embodiments, the charge management unit 708 is an energy management system (EMS) 516. As will be appreciated, the EMS 516 can be any electronic system that manages a rechargeable battery (cell or battery pack), such as by protecting the battery from operating outside its safe operating area, monitoring its state, calculating secondary data, reporting that data, controlling its environment, authenticating it and/or balancing it. The EMS 516 can be built together with a battery pack and an external communication data bus to form a smart battery pack that can be charged by smart battery charger. The EMS 516 can monitor the state of the battery or battery pack by sensing one or more of: voltage: total voltage, voltages of individual cells, minimum and maximum cell voltage or voltage of periodic taps; temperature: average temperature, coolant intake temperature, coolant output temperature, or temperatures of individual cells; state of charge (SOC) or depth of charge (DOD), to indicate the charge level of the battery or individual cells; state of health (SOH), a variously-defined measurement of the remaining capacity of the battery as percent (%) of the original capacity; state of power (SOP), the amount of power available for a defined time interval given the current power usage, temperature and other conditions; state of safety (SOS) coolant flow: for air or fluid cooled batteries; and/or current: current in or out of the battery.

Additionally, the EMS 516 may calculate values based on the above items, such as maximum charge current as a charge current limit (CCL); maximum discharge current as a discharge current limit (DCL); energy [kWh] delivered since last charge or charge cycle; internal impedance of a cell (to determine open circuit voltage); charge [Ah] delivered or stored (sometimes this feature is called Coulomb counter); total energy delivered since first use; total operating time since first use; and/or total number of cycles.

The EMS 516 can use the sensed parameters to protect, the battery pack by preventing it from operating outside its safe operating area and to maximize the battery pack's capacity, and prevent localized under-charging or over-charging. The EMS 516 can actively ensure that all the cells that compose the battery are kept at the same voltage or state of charge, through balancing. The EMS 516 can balance the cells by: wasting energy from the most charged cells by connecting them to a load (such as through passive regulators); shuffling energy from the most charged cells to the least charged cells (balancers); reducing the charging current to a sufficiently low level that will not damage fully charged cells, while less charged cells may continue to charge (does not apply to Lithium chemistry cells); and modular charging.

An embodiment of one or more loads 508 associated with the vehicle 100 may be as shown in FIG. 8. The loads 508 may include a bus or electrical interconnection system 802, which provides electrical energy to one or more different loads within the vehicle 100. The bus 802 can be any number of wires or interfaces used to connect the power generation unit 504 and/or power storage component 208 to the one or more loads 508. The converter 632c may be an interface from the power generation unit 504 or the power storage component 208 into the loads 508. The converter 632c may be the same or similar to electric converter 632a as shown in FIG. 6. Similar to the discussion of the converter 632b in FIG. 7, the converter 632c may be eliminated, if the electric converter 632a, shown in FIG. 6, is present. However, the converter 632c may further condition or change the energy characteristics for the bus 802 for use by the loads 508. The converter 632c may also provide electrical energy to electric motor 804, which may power the vehicle 100.

The electric motor 804 can be any type of DC or AC electric motor. The electric motor may be a direct drive or induction motor using permanent magnets and/or winding either on the stator or rotor. The electric motor 804 may also be wireless or include brush contacts. The electric motor 804 may be capable of providing a torque and enough kinetic energy to move the vehicle 100 in traffic. In some embodiments, the electric motor 804 may be similar, if not identical, to the electric motor 212 described in conjunction with FIG. 2.

The different loads 508 may also include environmental loads 812, sensor loads 816, safety loads 820, user interaction loads 808, etc. User interaction loads 808 can be any energy used by user interfaces or systems that interact with the driver and/or passenger(s) of the vehicle 100. These loads 808 may include, for example, the heads up display 434, the dash display 420, 424, 428, the radio, user interfaces on the head unit, lights, radio, and/or other types of loads that provide or receive information from the occupants of the vehicle 100. The environmental loads 812 can be any loads used to control the environment within the vehicle 100. For example, the air conditioning or heating unit of the vehicle 100 can be environmental loads 812. Other environmental loads can include lights, fans, and/or defrosting units, etc. that may control the environment within, and/or outside of, the vehicle 100. The sensor loads 816 can be any loads used by sensors, for example, air bag sensors, GPS, and other such sensors used to either manage or control the vehicle 100 and/or provide information or feedback to the vehicle occupants. The safety loads 820 can include any safety equipment, for example, seat belt alarms, airbags, headlights, blinkers, etc. that may be used to manage the safety of the occupants of the vehicle 100. There may be more, or fewer loads than those described herein, although they may not be shown in FIG. 8.

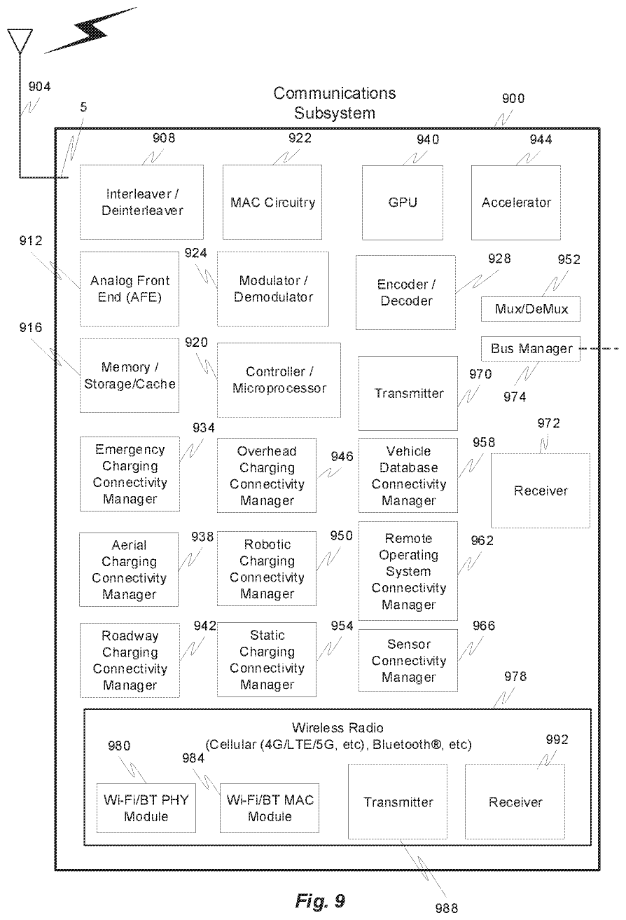

FIG. 9 illustrates a hardware diagram of communications componentry that can be optionally associated with the vehicle 100 in accordance with embodiments of the present disclosure.

The communications componentry can include one or more wired or wireless devices such as a transceiver(s) and/or modem that allows communications not only between the various systems disclosed herein but also with other devices, such as devices on a network, and/or on a distributed network such as the Internet and/or in the cloud and/or with other vehicle(s).

The communications subsystem can also include inter- and intra-vehicle communications capabilities such as hotspot and/or access point connectivity for any one or more of the vehicle occupants and/or vehicle-to-vehicle communications.

Additionally, and while not specifically illustrated, the communications subsystem can include one or more communications links (that can be wired or wireless) and/or communications busses (managed by the bus manager 974), including one or more of CANbus, OBD-II, ARCINC 429, Byteflight, CAN (Controller Area Network), D2B (Domestic Digital Bus), FlexRay, DC-BUS, IDB-1394, IEBus, I2C, ISO 9141-1/-2, J1708, J1587, J1850, J1939, ISO 11783, Keyword Protocol 2000, LIN (Local Interconnect Network), MOST (Media Oriented Systems Transport), Multifunction Vehicle Bus, SMARTwireX, SPI, VAN (Vehicle Area Network), and the like or in general any communications protocol and/or standard(s).

The various protocols and communications can be communicated one or more of wirelessly and/or over transmission media such as single wire, twisted pair, fiber optic, IEEE 1394, MIL-STD-1553, MIL-STD-1773, power-line communication, or the like. (All of the above standards and protocols are incorporated herein by reference in their entirety).

As discussed, the communications subsystem enables communications between any if the inter-vehicle systems and subsystems as well as communications with non-collocated resources, such as those reachable over a network such as the Internet.

The communications subsystem 900, in addition to well-known componentry (which has been omitted for clarity), includes interconnected elements including one or more of: one or more antennas 904, an interleaver/deinterleaver 908, an analog front end (AFE) 912, memory/storage/cache 916, controller/microprocessor 920, MAC circuitry 922, modulator/demodulator 924, encoder/decoder 928, a plurality of connectivity managers 934-966, GPU 940, accelerator 944, a multiplexer/demultiplexer 952, transmitter 970, receiver 972 and wireless radio 978 components such as a Wi-Fi PHY/Bluetooth® module 980, a Wi-Fi/BT MAC module 984, transmitter 988 and receiver 992. The various elements in the device 900 are connected by one or more links/busses 5 (not shown, again for sake of clarity).

The device 400 can have one more antennas 904, for use in wireless communications such as multi-input multi-output (MIMO) communications, multi-user multi-input multi-output (MU-MIMO) communications Bluetooth®, LTE, 4G, 5G, Near-Field Communication (NFC), etc., and in general for any type of wireless communications. The antenna(s) 904 can include, but are not limited to one or more of directional antennas, omnidirectional antennas, monopoles, patch antennas, loop antennas, microstrip antennas, dipoles, and any other antenna(s) suitable for communication transmission/reception. In an exemplary embodiment, transmission/reception using MIMO may require particular antenna spacing. In another exemplary embodiment, MIMO transmission/reception can enable spatial diversity allowing for different channel characteristics at each of the antennas. In yet another embodiment, MIMO transmission/reception can be used to distribute resources to multiple users for example within the vehicle 100 and/or in another vehicle.

Antenna(s) 904 generally interact with the Analog Front End (AFE) 912, which is needed to enable the correct processing of the received modulated signal and signal conditioning for a transmitted signal. The AFE 912 can be functionally located between the antenna and a digital baseband system in order to convert the analog signal into a digital signal for processing and vice-versa.

The subsystem 900 can also include a controller/microprocessor 920 and a memory/storage/cache 916. The subsystem 900 can interact with the memory/storage/cache 916 which may store information and operations necessary for configuring and transmitting or receiving the information described herein. The memory/storage/cache 916 may also be used in connection with the execution of application programming or instructions by the controller/microprocessor 920, and for temporary or long-term storage of program instructions and/or data. As examples, the memory/storage/cache 920 may comprise a computer-readable device, RAM, ROM, DRAM, SDRAM, and/or other storage device(s) and media.

The controller/microprocessor 920 may comprise a general-purpose programmable processor or controller for executing application programming or instructions related to the subsystem 900. Furthermore, the controller/microprocessor 920 can perform operations for configuring and transmitting/receiving information as described herein. The controller/microprocessor 920 may include multiple processor cores, and/or implement multiple virtual processors. Optionally, the controller/microprocessor 920 may include multiple physical processors. By way of example, the controller/microprocessor 920 may comprise a specially configured Application Specific Integrated Circuit (ASIC) or other integrated circuit, a digital signal processor(s), a controller, a hardwired electronic or logic circuit, a programmable logic device or gate array, a special purpose computer, or the like.

The subsystem 900 can further include a transmitter 970 and receiver 972 which can transmit and receive signals, respectively, to and from other devices, subsystems and/or other destinations using the one or more antennas 904 and/or links/busses. Included in the subsystem 900 circuitry is the medium access control or MAC Circuitry 922. MAC circuitry 922 provides for controlling access to the wireless medium. In an exemplary embodiment, the MAC circuitry 922 may be arranged to contend for the wireless medium and configure frames or packets for communicating over the wired/wireless medium.

The subsystem 900 can also optionally contain a security module (not shown). This security module can contain information regarding but not limited to, security parameters required to connect the device to one or more other devices or other available network(s), and can include WEP or WPA/WPA-2 (optionally+AES and/or TKIP) security access keys, network keys, etc. The WPA security access key is a security password used by Wi-Fi networks. Knowledge of this code can enable a wireless device to exchange information with an access point and/or another device. The information exchange can occur through encoded messages with the WPA access key often being chosen by the network administrator. In most cases, WEP has been replaced by the stronger WPA encryption method and keys.

In some embodiments, the communications subsystem 900 also includes a GPU 940, an accelerator 944, a Wi-Fi/BT/BLE PHY module 980 and a Wi-Fi/BT/BLE MAC module 984 and wireless transmitter 988 and receiver 992. In some embodiments, the GPU 940 may be a graphics processing unit, or visual processing unit, comprising at least one circuit and/or chip that manipulates and changes memory to accelerate the creation of images in a frame buffer for output to at least one display device. The GPU 940 may include one or more of a display device connection port, printed circuit board (PCB), a GPU chip, a metal-oxide-semiconductor field-effect transistor (MOSFET), memory (e.g., single data rate random-access memory (SDRAM), double data rate random-access memory (DDR) RAM, etc., and/or combinations thereof), a secondary processing chip (e.g., handling video out capabilities, processing, and/or other functions in addition to the GPU chip, etc.), a capacitor, heatsink, temperature control or cooling fan, motherboard connection, shielding, and the like.

The various connectivity managers 934-966 (even) manage and/or coordinate communications between the subsystem 900 and one or more of the systems disclosed herein and one or more other devices/systems. The connectivity managers include an emergency charging connectivity manager 934, an aerial charging connectivity manager 938, a roadway charging connectivity manager 942, an overhead charging connectivity manager 946, a robotic charging connectivity manager 950, a static charging connectivity manager 954, a vehicle database connectivity manager 958, a remote operating system connectivity manager 962 and a sensor connectivity manager 966.

The emergency charging connectivity manager 934 can coordinate not only the physical connectivity between the vehicle 100 and the emergency charging device/vehicle, but can also communicate with one or more of the power management controller, one or more third parties and optionally a billing system(s).

The vehicle database connectivity manager 958 allows the subsystem to receive and/or share information stored in the vehicle database. This information can be shared with other vehicle components/subsystems and/or other entities, such as third parties and/or charging systems. The information can also be shared with one or more vehicle occupant devices, such as an app (application) on a mobile device the driver uses to track information about the vehicle 100 and/or a dealer or service/maintenance provider. In general, any information stored in the vehicle database can optionally be shared with any one or more other devices optionally subject to any privacy or confidentially restrictions.

The remote operating system connectivity manager 962 facilitates communications between the vehicle 100 and any one or more autonomous vehicle systems. These communications can include one or more of navigation information, vehicle information, other vehicle information, weather information, occupant information, or in general any information related to the remote operation of the vehicle 100.

The sensor connectivity manager 966 facilitates communications between any one or more of the vehicle sensors and any one or more of the other vehicle systems. The sensor connectivity manager 966 can also facilitate communications between any one or more of the sensors and/or vehicle systems and any other destination, such as a service company, app, or in general to any destination where sensor data is needed.

In accordance with one exemplary embodiment, any of the communications discussed herein can be communicated via the conductor(s) used for charging. One exemplary protocol usable for these communications is Power-line communication (PLC). PLC is a communication protocol that uses electrical wiring to simultaneously carry both data, and Alternating Current (AC) electric power transmission or electric power distribution. It is also known as power-line carrier, power-line digital subscriber line (PDSL), mains communication, power-line telecommunications, or power-line networking (PLN). For DC environments in vehicles PLC can be used in conjunction with CAN-bus, LIN-bus over power line (DC-LIN) and DC-BUS.

The communications subsystem can also optionally manage one or more identifiers, such as an IP (internet protocol) address(es), associated with the vehicle and one or other system or subsystems or components therein. These identifiers can be used in conjunction with any one or more of the connectivity managers as discussed herein.

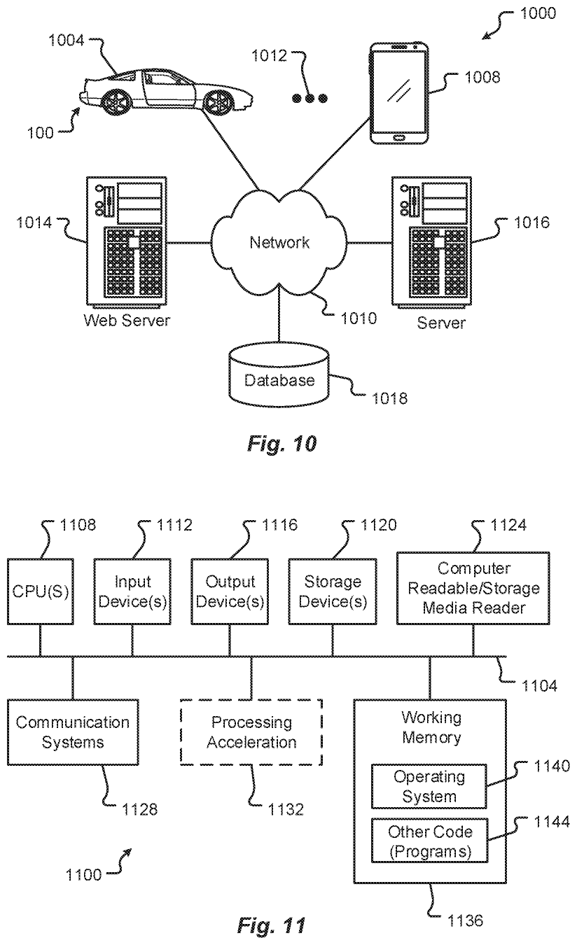

FIG. 10 illustrates a block diagram of a computing environment 1000 that may function as the servers, user computers, or other systems provided and described herein. The environment 1000 includes one or more user computers, or computing devices, such as a vehicle computing device 1004, a communication device 1008, and/or more 1012. The computing devices 1004, 1008, 1012 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These computing devices 1004, 1008, 1012 may also have any of a variety of applications, including for example, database client and/or server applications, and web browser applications. Alternatively, the computing devices 1004, 1008, 1012 may be any other electronic device, such as a thin-client computer, Internet-enabled mobile telephone, and/or personal digital assistant, capable of communicating via a network 1010 and/or displaying and navigating web pages or other types of electronic documents. Although the exemplary computer environment 1000 is shown with two computing devices, any number of user computers or computing devices may be supported.

Environment 1000 further includes a network 1010. The network 1010 may can be any type of network familiar to those skilled in the art that can support data communications using any of a variety of commercially-available protocols, including without limitation SIP, TCP/IP, SNA, IPX, AppleTalk, and the like. Merely by way of example, the network 1010 maybe a local area network (LAN), such as an Ethernet network, a Token-Ring network and/or the like; a wide-area network; a virtual network, including without limitation a virtual private network (VPN); the Internet; an intranet; an extranet; a public switched telephone network (PSTN); an infra-red network; a wireless network (e.g., a network operating under any of the IEEE 802.9 suite of protocols, the Bluetooth® protocol known in the art, and/or any other wireless protocol); and/or any combination of these and/or other networks.

The system may also include one or more servers 1014, 1016. In this example, server 1014 is shown as a web server and server 1016 is shown as an application server. The web server 1014, which may be used to process requests for web pages or other electronic documents from computing devices 1004, 1008, 1012. The web server 1014 can be running an operating system including any of those discussed above, as well as any commercially-available server operating systems. The web server 1014 can also run a variety of server applications, including SIP (Session Initiation Protocol) servers, HTTP(s) servers, FTP servers, CGI servers, database servers, Java servers, and the like. In some instances, the web server 1014 may publish operations available operations as one or more web services.

The environment 1000 may also include one or more file and or/application servers 1016, which can, in addition to an operating system, include one or more applications accessible by a client running on one or more of the computing devices 1004, 1008, 1012. The server(s) 1016 and/or 1014 may be one or more general purpose computers capable of executing programs or scripts in response to the computing devices 1004, 1008, 1012. As one example, the server 1016, 1014 may execute one or more web applications. The web application may be implemented as one or more scripts or programs written in any programming language, such as Java™, C, C#®, or C++, and/or any scripting language, such as Perl, Python, or TCL, as well as combinations of any programming/scripting languages. The application server(s) 1016 may also include database servers, including without limitation those commercially available from Oracle®, Microsoft®, Sybase®, IBM® and the like, which can process requests from database clients running on a computing device 1004, 1008, 1012.

The web pages created by the server 1014 and/or 1016 may be forwarded to a computing device 1004, 1008, 1012 via a web (file) server 1014, 1016. Similarly, the web server 1014 may be able to receive web page requests, web services invocations, and/or input data from a computing device 1004, 1008, 1012 (e.g., a user computer, etc.) and can forward the web page requests and/or input data to the web (application) server 1016. In further embodiments, the server 1016 may function as a file server. Although for ease of description, FIG. 10 illustrates a separate web server 1014 and file/application server 1016, those skilled in the art will recognize that the functions described with respect to servers 1014, 1016 may be performed by a single server and/or a plurality of specialized servers, depending on implementation-specific needs and parameters. The computer systems 1004, 1008, 1012, web (file) server 1014 and/or web (application) server 1016 may function as the system, devices, or components described in FIGS. 1-10.

The environment 1000 may also include a database 1018. The database 1018 may reside in a variety of locations. By way of example, database 1018 may reside on a storage medium local to (and/or resident in) one or more of the computers 1004, 1008, 1012, 1014, 1016. Alternatively, it may be remote from any or all of the computers 1004, 1008, 1012, 1014, 1016, and in communication (e.g., via the network 1010) with one or more of these. The database 1018 may reside in a storage-area network (SAN) familiar to those skilled in the art. Similarly, any necessary files for performing the functions attributed to the computers 1004, 1008, 1012, 1014, 1016 may be stored locally on the respective computer and/or remotely, as appropriate. The database 1018 may be any type of database, including a relational (e.g., Oracle 20I®), hierarchical, object-oriented, NoSQL, XML, and/or flat file database. The database 1018 includes database servers such as an SQL Server, SQLite, Oracle Database, Sybase, Informix, MySQL, MongoDB, or other database server.

In some embodiments, the databases 1018 included not only data associated with the state and operation vehicle but also information regarding vehicle ownership and associated owner information (such as owner contact, preference information, electronic calendar information regarding scheduled events, historical trips and driving information, and the like), sensor data collected historically and currently by vehicle sensors (described above), and power provider information, such as power provider rate schedules or plans and historical power consumption and utility invoices of the owner.

FIG. 11 illustrates one embodiment of a computer system 1100 upon which the servers, user computers, computing devices, or other systems or components described above may be deployed or executed. The computer system 1100 is shown comprising hardware elements that may be electrically coupled via a bus 1104. The hardware elements may include one or more central processing units (CPUs) 1108; one or more input devices 1112 (e.g., a mouse, a keyboard, etc.); and one or more output devices 1116 (e.g., a display device, a printer, etc.). The computer system 1100 may also include one or more storage devices 1120. By way of example, storage device(s) 1120 may be disk drives, optical storage devices, solid-state storage devices such as a random-access memory (RAM) and/or a read-only memory (ROM), which can be programmable, flash-updateable and/or the like.

The computer system 1100 may additionally include a computer-readable storage media reader 1124; a communications system 1128 (e.g., a modem, a network card (wireless or wired), an infra-red communication device, etc.); and working memory 1136, which may include RAM and ROM devices as described above. The computer system 1100 may also include an optional processing acceleration unit 1132, which can include a DSP, a special-purpose processor, and/or the like.

The computer-readable storage media reader 1124 can further be connected to a computer-readable storage medium, together (and, optionally, in combination with storage device(s) 1120) comprehensively representing remote, local, fixed, and/or removable storage devices plus storage media for temporarily and/or more permanently containing computer-readable information. The communications system 1128 may permit data to be exchanged with a network and/or any other computer described above with respect to the computer environments described herein. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information.

The computer system 1100 may also comprise software elements, shown as being currently located within a working memory 1136, including an operating system 1140 and/or other code 1144. It should be appreciated that alternate embodiments of a computer system 1100 may have numerous variations from that described above. For example, customized hardware might also be used and/or particular elements might be implemented in hardware, software (including portable software, such as applets), or both. Further, connection to other computing devices such as network input/output devices may be employed.

Examples of the processors 1108 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARIV1926EJ-S™ processors, other industry-equivalent processors, and may perform computational functions using any known or future-developed standard, instruction set, libraries, and/or architecture.

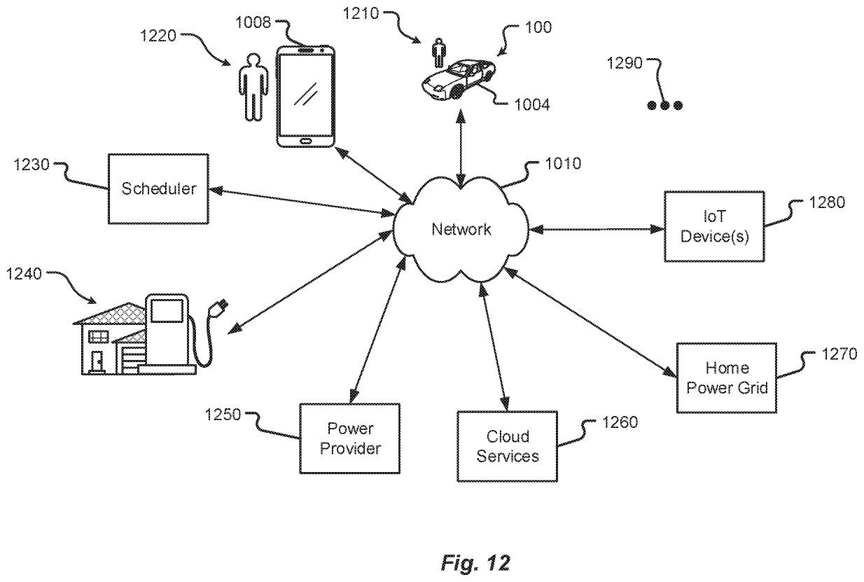

Referring to FIG. 12, the vehicle 100 is shown in a charging environment. Other embodiments are possible but may not be depicted in FIG. 12. Generally, the vehicle 100 is charged in a charging environment where the charging schedule is calculated based on information provided by the vehicle 100, an occupant 1210 via instrument panel 400, a user 1220 via a user device(s) 1008, a scheduler 1230, a charging station 1240, a power provider 1250, cloud services 1260, a home power grid 1270, one or more Internet of Things (IoT) device(s) 1280, and/or other systems or devices 1290 connected to the network 1010 and/or via a direct wireless or wired connection. In some embodiments, power provided by the power provider 1250 is used to charge the vehicle 100 (e.g., drive power source 704) is received at the plug/receptacle 304 from the charging station 1240 during time periods specified in the charging schedule.

The scheduler 1230 generates the charging schedule based on information provided by the vehicle computing device 1004, the user device(s) 1008, the occupant 1210, the user 1220, the charging station 1240, the power provider 1250, the cloud services 1260, the home power grid 1270, the one or more IoT device(s) 1280, and/or the other systems or devices 1290. The information used to create the charging schedule may be stored in a database 1018, the cloud services 1260, the communication device(s) 1008, the vehicle computing device 1004, the web server 1014, the application server 1016, and/or other storage device. The scheduler may be incorporated or a subsystem of the vehicle computing device 1004, the charging station 1240, the power provider 1250 (e.g., mains electricity), the cloud services 1260, the home power grid 1270, the one or more IoT device(s) 1280, and/or the other systems or devices 1290.

An occupant 1210 and/or a user 1220 may provide information to the scheduler 1230 including a driving schedule or access to the user's electronic calendar, a charge time completion requirement, a minimum SOC, a maximum SOC, a maximum cost of charging, a request to minimize the cost of charging, a charging priority, and/or the like. The number of miles expected to travel the following day based on the driving schedule and/or scheduled activities in the electronic calendar may set a minimum SOC required and may include a predefined safety buffer (e.g., an additional 10% above the minimum SOC required). The number of miles expected to be driven in the future based on the driving schedule may also impact daily charging schedules (e.g., charging to a higher SOC one night to reduce the length of charging time in the future). The driving schedule may provide a charging completion time requirement (e.g., when the driver expects to start the vehicle 100) or a person may provide a charge time completion requirement. The minimum and maximum SOC set lower and upper limits, respectively, on the SOC after charging. The maximum cost of charging or prevailing service provider rate schedule or plan coupled with the power requirements of the vehicle based on the driving schedule or scheduled activities (e.g., vehicle current SOC, anticipated power usage for each scheduled activity, and, for each time period between scheduled activities, how much charging is required to meet the power requirements of the next set of scheduled activities during which no vehicle charging may occur) may determine the time periods that the vehicle 100 is charged (e.g., off-peak hours of the power provider 1250) and the rate or level of charging during the time periods. In some embodiments, a charging profile is generated that includes a series of time intervals and, for each time interval, a rate or level of charging that can satisfy anticipated power demands while substantially minimizing charging costs. In some embodiments, the power usage by the home power grid 1270 is considered in determining when to charge and the charging rate. The charging priority may provide an order of electricity usage. For example, if the IoT device 1280 associated with an electric dryer communicates a drying time to the scheduler 1230, then the charging of the vehicle 100 may be delayed until the electric dryer is finished. On the other hand, charging of the vehicle 100 may be have higher priority. In this case, the electric dryer operation may be delayed until the vehicle 100 is not being charged.

The charging station 1240 is an external power source used to charge the vehicle 100 (e.g., one or more drive power sources 704). The charging station 1240 may be associated with a home or personal distribution power system. In some cases, the charging station 1240 may provide power via one or more components associated with a home. For example, the power providing components may be built into a portion of a home, building, driveway, lot, etc. The power providing components may provide power wirelessly (e.g., induction, non-contact coupling, etc.) and/or directly (e.g., via direct coupling, plug-and-receptacle, contact coupling, etc.). The power provider 1250 may provide electrical power to the charging station 1240 that is used to charge the rechargeable energy storage of the vehicle 100.

The charging station 1240 may be a Level 1 charger that uses a 120 VAC plug and can be plugged into a standard outlet, a Level 2 charger that uses a 240 VAC (for residential) or 208 VAC (for commercial) plug, and/or a Level 3 fast charger that requires high-powered equipment but significantly decreases charging time. Typically, a Level 2 charger charges at twice the rate of a Level 1 charger. As a result, the scheduler must consider the level of charger used during each charging time period when generating the charging schedule. The charging station 1240 may provide one or more charger levels 1-3 while charging vehicle 100 during a charging session comprising one or more charging time periods. The charger level is one factor used to generate the charging schedule.

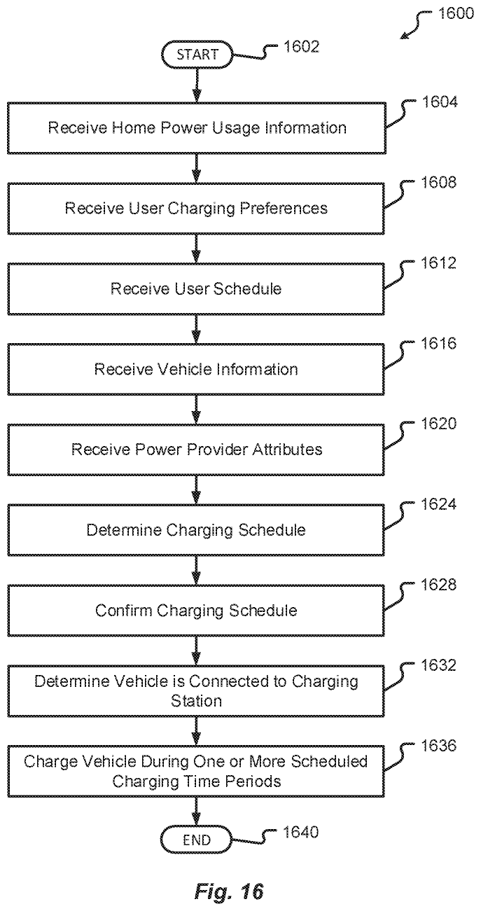

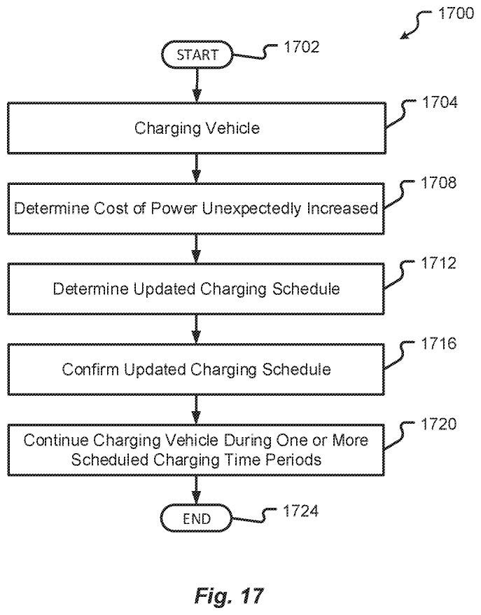

As described above, the power provider 1250 provides attributes via the network 1010 to the scheduler 1230. The power provider attributes along with other information are used to generate the charging schedule for vehicle 100, as described FIGS. 16 and 17. Typically, the power provider attributes are dynamic and may depend on, for example, local demand, to apply premium pricing during periodic or temporary high-demand periods. The attributes may comprise, for example, multipliers, divisors, additional charges, discount amounts, and/or other factors that can be applied by the scheduler 1230 to adjust a charging cost up or down for given conditions. Any number and variety of other attributes can be implemented in different ways at the power provider's discretion and are considered to be within the scope of the present disclosure.

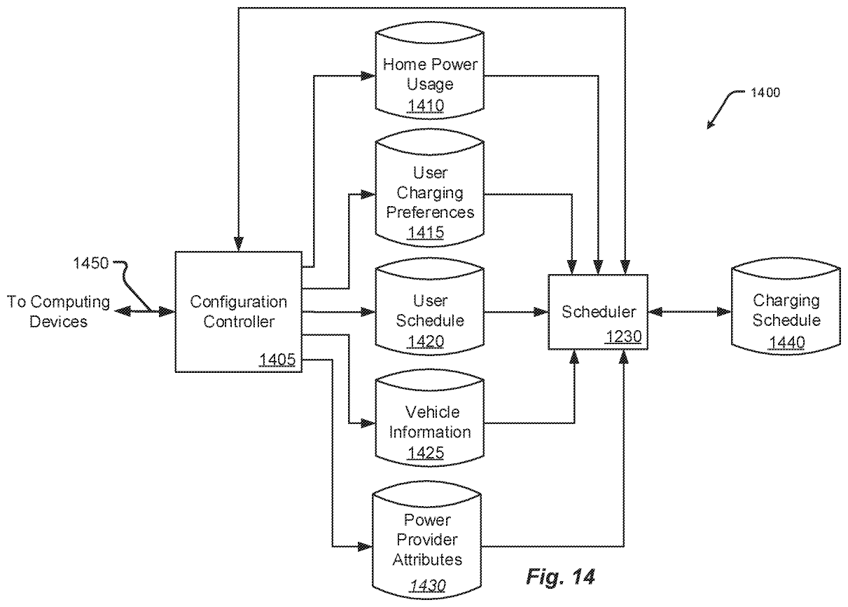

The cloud services 1260 may provide storage and/or implement a portion or the entire functionality of the scheduler 1230. For example, the cloud services 1260 may comprise Amazon Alexa™, Google Assistant™, Apple Siri™, and/or the like. The cloud services 1260 may implement the methods shown in FIGS. 16 and 17, and/or provide repository storage as shown in FIG. 14.

The home power grid 1270 may comprise a smart grid that may include a variety of operational and energy measures, including one or more smart meters, smart appliances, renewable energy resources, and energy efficiency resources. Home power grid 1270 may support one or more data flow and information management systems, including wireless infrared, Bluetooth®, Wi-Fi™, Z-Wave™, ZigBee®, IEEE 802.11, X10, and/or other wired or wireless technology standards. Home power grid 1270 may also include cloud-based services, such as Amazon Alexa™, Google Assistant™, Apple Siri™, Apple Homekit™ framework, and/or the like. The charging station 1240 may be incorporated into the home power grid 1270.

The home power grid 1270 may communicate with a home smart meter to collect historic power usage measurements and power provider 1250 attributes. The historic power usage measurements and the power provider attributes may be used by the scheduler 1230 to generate the charging schedule, as shown in FIGS. 14-17.

The IoT device(s) 1280 may comprise one or more devices that communicate through the network 1010 and/or a separate network that may include the home power grid 1270. The IoT device(s) 1280 may provide information to the scheduler 1230 to allow the charging schedule to depend on current or scheduled power usage of the IoT device(s) 1280. In some embodiments, one or more IoT device(s) 1280 delay operation during charging time periods.

The other systems or devices 1290 may comprise a web server 1014, a server 1016, and/or a database 1018, as shown in FIG. 10. The other systems or devices 1290 may comprise other systems and devices that are known in the art.

In some embodiments, one or more of the power sources 208 are dropped off at the charging station 1240 to be charged during off peak hour power rates while the remaining power sources 208 power the vehicle 100. Balancing of the plurality of power sources 208 may be required after charging.

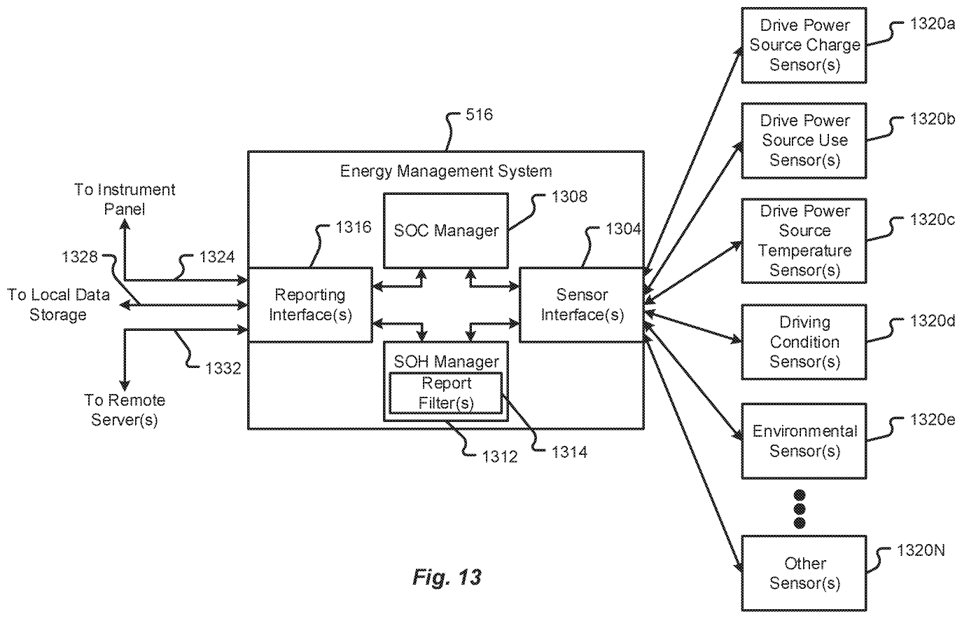

Referring now to FIG. 13, additional details of an energy management system 516 and sensors 1320 will be described in accordance with at least some embodiments of the present disclosure. The energy management system 516 is shown to include one or more sensor interfaces 1304, an SOC manager 1308, a SOH manager 1312, and one or more reporting interfaces 1316. The sensor interface(s) 1304 enable the energy management system 1304 to receive information from one or more battery state sensors 1320a-N. In particular, different interfaces 1304 may be provided for different sensors, depending upon the nature of the senor, the format of the sensor input provided to the energy management system 516, and other factors. Examples of sensors 1320 that may provide input to the energy management system 516 include, without limitation, drive power source charge sensor(s) 1320a, drive power use sensor(s) 1320b, drive power temperature sensor(s) 1320c, driving condition sensor(s) 1320d, environmental sensor(s) 1320e, and other SOH/SOC sensor(s) 1320N. Information may be provided from the sensors to the energy management system 516 in the form of basic analog or digital signals. Alternatively, or additionally, the sensor(s) 1320a-N may provide voltage or current readouts that are converted by the sensor interface(s) 1304 into an appropriate reading or data that represents a SOH condition. The sensor(s) 1320a-N may provide sensor readings to the energy management system 516 on a continuous, periodic, non-periodic basis. In particular, readings from the sensor(s) may be provided to the energy management system 516 only in response to certain conditions being met (e.g., a change in measured state occurring) or the readings may be provided continuously without regard for any state change.

In some embodiments, the drive power charge sensor(s) 1320a may provide data indicative of a current charge state for a battery, cell, module, or any other type of power storage component 208. The drive power source charge sensor(s) 1320a may be used as a source of information about a current state of a battery or drive power source. As such, information received from the drive power source charge sensor(s) 1320a may be used by the SOC manager 1308 to report current charge information for the batteries. Alternatively or additionally, the SOC manager 1308 may take the information received from the drive power source charge sensor(s) 1320a and convert that information into reportable information that describes a current state of the drive power source's charge (e.g., 50% charge remaining, 100% charged, 10% charge, etc.), a remaining range of the vehicle 100 (e.g., 100 miles to empty, 10 km to no charge, etc.), or the like. In some embodiments, the drive power source charge sensor(s) 1320a may include a measurement system or collection of sensors that measure charge or discharge current flowing through a battery, voltage across battery terminals, and/or temperature of the battery itself. As such, the sensor(s) 1320a may include one or many transducers that detect physical phenomena (e.g., temperature, current, voltage, etc.) and convert the detected physical phenomena into an output current, voltage, or similar type of electronic signal (which can be digital or analog). The sensor(s) 1320a may include one or more shunts or shunt circuits that enable the sensing of battery currents. The sensor(s) 1320a may also include one or more integrated processors that detect or determine a drive power source's SOC.

The drive power source use sensor(s) 1320b, in some embodiments, may correspond to one or more transducers that help determine whether and/or to what extent batteries are being used. It may be possible to incorporate functionality of the drive power source use sensor(s) 1320b into the drive power source charge sensor(s) 1320a as changes in battery charge or SOC may signify that the battery is currently in use or has recently been used. A drive power source use sensor(s) 1320b may help to determine, in a binary fashion, whether a battery is currently connected to a load, for example. A drive power source use sensor(s) 1320b may also detect when a battery is not in use—again in a binary fashion. The drive power source use sensor(s) 1320b may also detect which particular loads in the vehicle 100 are currently drawing power from a battery or set of batteries. In this way, the drive power source use sensor(s) 1320b can help determine the operational loads being placed on batteries in addition to determining whether current is simply being drawn from the batteries. As can be appreciated, the drive power source use sensor(s) 1320b can be incorporated into or nearby loads of the vehicle rather than the batteries themselves. Alternatively, or additionally, the drive power source use sensor(s) 1320b may be utilized to determine whether batteries are subjected to fast charges or normal charges. Knowledge of whether a battery is being subjected to a fast charge or normal charge can help to determine or predict future performance of a battery (e.g., excessive fast charges can negatively impact long-term battery performance including overall capacity, ability to maintain a full charge, etc.). Accordingly, as fast charges are detected at the drive power source use sensor(s) 1320b, the SOH manager 1312 may be notified of such information.

The drive power source temperature sensor(s) 1320c may correspond to one or more thermal transducers that measure a physical temperature at or near a battery (or battery cell). The temperatures measured by the sensor(s) 1320c may be in Fahrenheit, Celsius, etc. The temperature(s) measured by the sensor(s) 1320c may be reported continuously or periodically without departing from the scope of the present disclosure.

The driving condition sensor(s) 1320d may include one or many sensors that help detect the way in which a vehicle is being driven (e.g., via manual input, autonomously, semi-autonomously, etc.). The driving condition sensor(s) 1320d may also detect routes driven by the vehicle 100, acceleration profiles, deceleration profiles, braking profiles, and the like. The driving condition sensor(s) 1320d may include one or more accelerometers, GPS systems, motion sensors, rotation sensors, or the like. In particular, the driving sensor(s) 1320d may help to collect information that describes how a vehicle 100 is being driven, which can be potentially correlated to battery performance. For instance, aggressive driving (e.g., driving in which significant accelerations and decelerations are performed) may result in degraded performance for a battery over its life due to significant and drastic swings in loads applied to the batteries.

The environmental sensor(s) 1320e may include one or many sensors that are used to detect environmental conditions about the vehicle 100 and/or batteries. In particular, humidity, barometric pressure, temperature, and the like can be measured by the environmental sensor(s) 1320e. The environmental conditions to which the batteries are subjected may impact their long-term performance (e.g., their SOH) and their possible performance degradation over time. The environmental sensor(s) 1320e may, in some embodiments, help to detect conditions around the batteries as opposed to detecting conditions of the batteries themselves.

The other SOH/SOC sensor(s) 1320N may include any other type of sensor or transducer that is useful in detecting conditions that might have an impact on battery SOH/SOC. For instance, sensors that detect battery or cell impedance, battery or cell conductance, battery or cell internal resistance, self-discharge, charge acceptance, and so on may be included on the other SOH/SOC sensor(s) 1320N.

The energy management system 516 may accept the sensor inputs at the sensor interface(s) 1304 and carry those inputs to one or both of the SOC manager 1308 and SOH manager 1312. As the names suggest, the SOC manager 1308 is responsible for determining and reporting information related to the drive power source SOC whereas the SOH manager 1312 is responsible for determining and reporting information related to the drive power source SOH.

As used herein, the SOH of a power source, battery, cell, module, or the like (generally referred to as a battery for ease of discussion) is a measurement or representation that reflects the general condition of a battery and its ability to deliver a specified performance compared with a fresh or new battery. Battery SOH takes into account such factors as charge acceptance, internal resistance, voltage and self-discharge. SOH is a measure of the long-term capability of the battery and gives an indication, rather than an absolute measurement, of how much of the available possible energy throughput of the battery has been consumed, and how much is left. Using the automotive analogy, the battery SOH for an electric or hybrid electric vehicle can be compared to the odometer display function which indicates the number of miles travelled since the vehicle was new.

As compared to SOH, the SOC of a battery represents the short-term capability of the battery. During the lifetime of a battery, its performance or health will deteriorate gradually due to irreversible physical and chemical changes which take place with usage (normal or abnormal) and with age until eventually the battery is no longer usable or dead. The SOH is an indication of the point which has been reached in the life cycle of the battery and a measure of its condition relative to a fresh or new battery. Unlike the SOC which can be determined by measuring the actual charge in the battery there is no absolute definition of the SOH. It is a subjective measure that can be derived from a variety of different measurable battery performance parameters which can be interpreted according to different rule sets. Accordingly, SOH is an estimation rather than a measurement; however, the more information related to SOH that is known or presented to a user may help in determining, with more accuracy, the relative SOH of a battery as compared to other battery SOHs. The SOH only applies to batteries after they have started their ageing process either on the shelf or once they have entered service.

In some embodiments, any parameter which changes significantly with age, such as cell impedance or conductance, can be used as a basis for providing an indication of the SOH of the cell. The types of battery or cell parameters which may be measured in connection with determining SOH include, without limitation, capacity, internal resistance, self-discharge, charge acceptance, discharge capabilities, mobility of electrolytes, and cycle-counting (e.g., number of charge and discharge cycles the battery or cell has been subjected to). The absolute readings of these parameters will likely depend on the cell chemistry involved. In some embodiments, weighting can be added to individual factors based on experience, the cell chemistry, and the importance the particular parameter in the application for which the battery is used. If any of these variables provide marginal readings, the end result will be affected. A battery may have a good capacity but the internal resistance is high. In this case, the SOH estimation will be lowered accordingly. Similar demerit points are added if the battery has high self-discharge or exhibits other chemical deficiencies. The points scored for the cell can be compared with the points assigned to a new cell to give a percentage result or figure of merit.

As can be appreciated, the logic employed by the SOC manager 1308 may be relatively simple in that any information related to current battery charge can be received from the sensor interface 1304 and promptly reported via the reporting interface(s) 1316. The information reported by the SOC manager 1308 may be provided to the instrument panel via signal path 1324, to local data storage via signal path 1328, and/or to remote server(s) via signal path 1332. The SOC manager 1308 may continuously or in response to requests report the current SOC for a battery, a set of batteries, or the like.

The SOH manager 1312, on the other hand, may be responsible for receiving and processing the information from the sensor interface(s) 1304 to calculate a SOH reading. Alternatively, or additionally, the SOH manager 1312 may apply one or more report filters 1314 that enable the SOH manager 1312 to simply report desired SOH information to desired recipients. The SOH manager 1312, in some embodiments, may utilize its report filter(s) 1314 to determine that a first set of SOH information is to be transmitted to the instrument panel via signal path 1324 whereas a different set of SOH information is to be transmitted to local data storage via signal path 1328. Similarly, the SOH manager 1312 may utilize its report filters 1314 to determine that a third set of SOH information is to be transmitted to remote server via signal path 1332 for further processing and analysis.

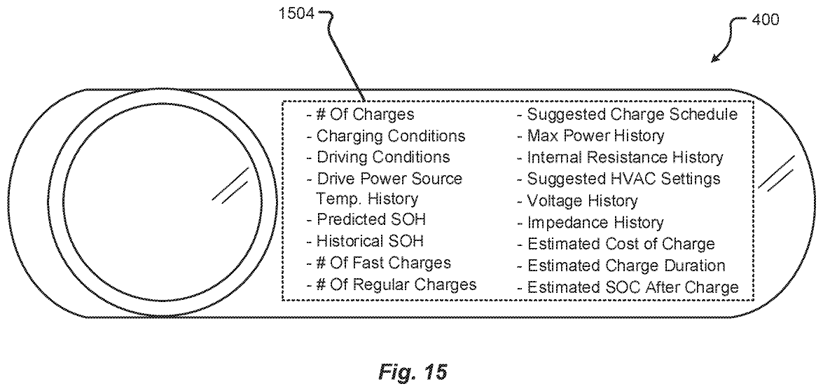

As a non-limiting example, the SOH manager 1312 may simply report a calculated SOH to the instrument panel (e.g., instrument panel 400, as shown in FIGS. 4 and 15) for presentation to a driver of the vehicle 100, whereas the SOH manager 1312 may report parameters used for calculating the SOH to local data storage and/or remote servers. The usefulness of sending the measured parameters rather than the calculated SOH value to the local data storage and/or remote servers is that the actual parameters can be logged and/or compared to previously-obtained parameters to determine long-term trends in each of the parameters. Analysis of the changes in parameters can help in determining a more accurate or representative SOH calculation. In some embodiments, it may be possible to send the SOH parameters to a remote server, which compares the parameters with historical readings of the same parameters, determines a current SOH calculation and then reports back the SOH calculation to the vehicle 100. The SOH calculation made at the remote server may then be presented to the drive of the vehicle 100 via the instrument panel 400.

As can be appreciated, the SOH manager 1312 may utilize a plurality of different report filters 1314 and each report filter may filter out certain types of information depending upon the desired recipient of the report, user preferences for such reports (user charging preferences 1415), and the like. The report filter(s) 1314 may be user-configurable or configurable by manufacturers of the batteries. The report filter(s) 1314 can be used to ensure that unnecessary or unwanted data is not sent along a particular signal path 1324, 1328, 1332, thereby preserving network and/or processing resources.

FIG. 14 is a block diagram illustrating components of a system for determining a charging schedule 1440 according to one embodiment of the present disclosure. As illustrated in this example, a scheduling system 1400 can comprise a configuration controller 1405, one or more repositories of rules and information including but not limited to a repository of home power usage 1410, a repository of user charging preferences 1415, a repository of a user schedule 1420, a repository of vehicle information 1425, and a repository of power provider attributes 1430. The scheduling system 1400 can further comprise a scheduler 1230, as described in FIG. 12, a charging schedule 1440 stored in a repository, and a signal path 1450 to computing devices. Generation of the charging schedule 1440 based on the information, rules, and attributes stored in the repositories is further described in FIGS. 16 and 17.

Generally speaking, the scheduling system 1400 can, for example use a graphical or other user interface provided by the configuration controller 1405 (e.g., via the SOH/SOC display 1504, a display associated with the charging station 1240, a display on a communication device 1008, a device in the home (television, home computer, IoT devices, etc.), and/or a display associated with the home power grid 1270), display the information, rules, and attributes contained in the repositories, SOH, SOC, and/or charging schedule. In some embodiments, a user may approve the charging schedule 1440 and/or receive notification of the charging schedule 1440.

The repository of home power usage 1410 can comprise information for one or more power loads (e.g., clothes washer, clothes dryer, home HVAC, etc.) defined by a power provider (e.g., power provider 1250), one or more IoT devices (e.g., IoT device(s) 1280), and/or a home power grid (e.g., home power grid 1270) through the configuration controller 1405. In some embodiments, the charging schedule 1440 may require one or more power loads to delay operating during charging periods to balance home power usage. For example, an electric clothes dryer may delay operating until a charge period of the vehicle is complete.

The repository of user charging preferences 1415 can comprise charging preferences defined by one or more users inputting the information through the configuration controller 1405 (e.g., via the SOH/SOC display 1504, a user input device associated with the charging station 1240, a user input device of a communication device 1008 and/or a user input device associated with the home power grid 1270). User charging preferences 1415 may comprise charge until full, charge until SOC met, charge until a minimum SOC is met then wait until off peak hour pricing, charge only during off peak hour pricing, charge to minimize charging costs while maintaining a selected minimum SOC in view of scheduled travel, charge during a time period, charge until a cost is met, charge until an SOC is met that provides travel for a predetermined distance, rate of charge (e.g., charger Level 1-3), priority of charging relative to other devices connected to the home power grid, and/or the like.

The repository of user schedule 1420 can comprise information for one or more users defined by one or more user electronic or digital calendars through the configuration controller 1405. The user schedule 1420 may include the distance required to travel before recharging, the time of day that a user may start to travel, etc. The user schedule may be stored in one or more calendars located on one or more devices (e.g., a communication device 1008, cloud services 1260, etc.). An example of a user calendar is an Outlook™ calendar.

The repository of vehicle information 1425 can comprise information for one or more vehicles defined sources of data within the vehicle (e.g., power management controller 224, EMS 516, etc.) through the configuration controller 1405. The information stored in the repository of vehicle information 1425 can comprise values for variables defined in the calculations or actions of the scheduler 1230. In other cases, the information can comprise switches, flags, or other values for the conditions of the rules. For example, vehicle information may define a type of equipment, e.g., a battery type, suitable for use in a particular one or more vehicles, power usage or requirements of that vehicle in operation, current SOH/SOC, and/or other information. The vehicle information may comprise driver behavior information (e.g., how quickly the driver accelerates; percent city driving versus highway driving; use of air conditioning and duration; use of heating and duration; etc.) used to determine the average amount of power required per mile driven. The vehicle-specific information can also be used when the scheduler 1230 generates the charging schedule 1440 in order to select or determine appropriate power source charge level to meet a requested amount of power. For example, a charging station that supports one or more charging levels (e.g., Levels 1-3) may follow the instructions stored in the charging schedule 1440 to determine the charging level during charging.

The power provider can, for example, through the graphical or other user interface of the configuration controller 1405, define and/or adjust selectable or configurable parameters stored in the repository of power provider attributes 1430 to be used by scheduler 1230 to generate a charging schedule 1440. These attributes can comprise, for example, values for variables defined in the calculations or actions of the attributes. In other cases, the attributes can comprise switches, flags, or other values for the conditions. Exemplary attributes define a rate schedule or plan in which charging pricing is indexed or mapped against time and/or power consumption. The attributes stored in the repository of power provider attributes 1430 may be varied by the power provider through the configuration controller 1405 to define power costs over time, charge duration, maximum power loads, etc. Additionally or alternatively, the power provider attributes 1430 may be stored in a searchable data structure provided by the power provider that is accessible through a network connection (e.g., via the Internet over the network 1010).

The scheduler 1230 generates the charging schedule 1440 based on the information stored in the repositories. As described above, the information contained in a repository may be accessible through a network connection and/or the information may be co-located with the scheduler 1230. Typically, the scheduler 1230 reduces or minimizes the cost of charging based on the information stored in the repositories. For example, when a power provider reduces the cost of power during off peak hours, the scheduler 1230 may prefer to schedule charging time periods during these off-peak hours. Alternatively, the scheduler 1230 may generate a charging schedule 1440 that balances the power usage over time for the home power grid by delaying operation of IoT capable devices, adjusting the charger level of the charging station, charging during time periods when a home generator generates power (e.g., solar panels generating power during periods of sunlight), etc.

The charging schedule 1440 may be provided to the charging station (e.g., charging station 1240), to the home power grid (e.g., home power grid 1270), to IoT devices (e.g., IoT device(s) 1280), to computing devices 1004, 1008, and/or 1012 via the configuration controller 1405 signal path 1450. In some embodiments, the charging schedule 1440 may be stored on a cloud service and be accessible through a network connection. Additionally or alternatively, the repositories may comprise memory storage of cloud services (e.g., cloud services 1260) and/or database 1018, as shown in FIG. 10.

With reference now to FIG. 15, additional details of the types of information that can be displayed to a user via the instrument panel 400 will be described in accordance with at least some embodiments of the present disclosure. The instrument panel 400 is shown to depict multiple types of SOH and SOC information or parameters that contribute to a SOH and SOC determination. It should be appreciated that some or all of this information may be presented simultaneously, sequentially, or in other formats to a user of the vehicle 100. It should also be appreciated that the illustrative information may not be displayed at all—at least until such time that a driver requests a presentation of such information on their instrument panel 400. FIG. 15 also shows that certain types of suggestions to improve battery SOH and SOC can also be displayed on the instrument panel 400.

The illustrative types of information that may be displayed on the instrument panel 400 include, without limitation, a count of the number of charges (e.g., for a lifetime of a drive power source or since some predetermined event), charging conditions (e.g., environmental conditions around the time of a drive power source charge), driving conditions (e.g., acceleration information, deceleration information, route information, etc.), drive power source temperature history (in table or graphical form), predicted SOH, historical SOH, a count of the number of fast charges (e.g., in total or as a ratio of the total number of charges), a count of the number of regular charges (e.g., in total or as a ratio of the total number of charges), suggested charge schedule (e.g., a charging schedule 1440 generated by the scheduler 1230, as shown in FIGS. 12 and 14), max power history, internal resistance history, suggested HVAC settings, voltage history, impedance history, estimated cost of the next charge, estimated charge duration (also called charge time), estimated SOC after charge (e.g., the estimated SOC after the estimated charge duration), and the like. The information may be presented in a SOH/SOC display 1504 of the instrument panel 400. The SOH/SOC display 1504 may correspond to one of many display options available via the panel 400. The information presented in the SOH/SOC display 1504 may be presented as raw data, in a graphical format, or as a SOH/SOC calculation that accounts for some or all of the presented data. Furthermore, any suggestions to improve SOH/SOC performance may be presented to the user in a different portion of the instrument panel 400 or in such a way that the suggestion is more prominent to the driver (e.g., as bolded font, at a higher location of the display, etc.). The user may be allowed to navigate or toggle through the various types of information presented in the SOH/SOC display 1504.

In some embodiments the SOH/SOC display 1504 may be displayed on a charging station display (e.g., charging station 1240, as shown in FIG. 12). Additionally or alternatively, the SOH/SOC display 1504 may be displayed on communication device 1008, as shown in FIGS. 10 and 12, and/or a display associated with the home power grid 1270, as shown in FIG. 12.

FIG. 16 is a flowchart illustrating a method 1600 for creating the vehicle charging schedule 1440 according to a further embodiment of the present disclosure. While a general order for the steps of the method 1600 is shown in FIG. 16, the method 1600 can include more or fewer steps or can arrange the order of the steps differently than those shown in FIG. 16.

The method 1600 begins at start operation 1602. At step 1604, a scheduler (e.g., scheduler 1230, as shown in FIGS. 12 and 14) optionally receives home power usage information. The home power usage information may be provided by the power provider, IoT devices, a home power grid, a smart meter, and/or the like. The home power usage information may comprise past, current, and/or predicted/scheduled future power consumption. At step 1608, the scheduler 1230 receives user charging preferences. Using charging preferences are described in FIGS. 12 and 14, and may comprise charge until full, charge until SOC met, charge during a time period, charge until a cost is met, charge until an SOC is met that provides travel for a predetermined distance, rate of charge (e.g., charger Level 1-3), priority of charging relative to other devices connected to the home power grid, and/or the like.

At step 1612, the scheduler 1230 optionally receives one or more user schedules and optionally user preferences with respect to charging. As described in FIG. 14, the user schedules may include the distance required to travel before recharging, the time of day that a user may start to travel, etc. The scheduler 1230 may use the user schedules to determine required SOC, maximum length of charging duration, time of day that charging must be completed, etc.

At step 1616, the scheduler 1230 optionally receives vehicle information for a vehicle 100. Vehicle information may define a type of equipment, e.g., a battery type, suitable for use in a particular one or more vehicles, power usage or requirements of that vehicle in operation, current SOH/SOC, and/or other information, as described in FIG. 14.

At step 1620, the scheduler 1230 optionally receives power provider attributes, as described in FIGS. 12 and 14. Typically, the power provider attributes are dynamic and may depend on, for example, local demand, to apply premium pricing during periodic or temporary high-demand periods. The attributes may comprise, for example, multipliers, divisors, additional charges, discount amounts, and/or other factors that can be applied by the scheduler to adjust a charging cost up or down for given conditions. Any number and variety of other attributes can be implemented in different ways at the power provider's discretion and are considered to be within the scope of the present disclosure.

At step 1624, the scheduler 1230 determines the charging schedule 1440 based on the information, preferences, and attributes described above. The charging schedule 1440 will define charging rate or level, start times, end times for charging time periods, and/or the like. The charging schedule 1440 may also include delaying operation of IoT devices, as described in FIGS. 12 and 14.

At step 1628, the scheduler optionally notifies one or more users of the charging schedule 1440 and provides a user the opportunity to confirm the charging schedule 1440. In some embodiments, a user preference is defined for one or more users that determines whether a user is giving an opportunity to confirm the charging schedule 1440, to be notified of the charging schedule 1440, or not be notified of the charging schedule 1440.

At step 1632, a charging station (e.g., charging station 1240) determines that a vehicle is connected. This connection may be determined from one or more charging sensors, charge controllers, proximity sensors, and/or some other switch or sensor associated with the charging receptacle of the vehicle 100 and/or the charging system. For instance, where the one or more switches and/or sensors provide a signal indicating the vehicle 100 is connected to a charging system. Additionally or alternatively, the energy management system 516, or other element of the vehicle 100, may poll a charging contact point to detect a connection to the charging station 1240. Polling of the charging contact point continues until a connection to the charging station 1240 is established. Once the connection has been established, the method 1600 transitions to step 1636.

At step 1636, the charging station 1240 charges the vehicle 100 during one or more scheduled charging time periods as determined in the charging schedule 1440 generated by the scheduler 1230. After step 1636, the method 1600 ends at end operation 1640.

FIG. 17 is a flowchart illustrating a method 1700 for updating the vehicle charging schedule 1440 according to a further embodiment of the present disclosure. While a general order for the steps of the method 1700 is shown in FIG. 17, the method 1700 can include more or fewer steps or can arrange the order of the steps differently than those shown in FIG. 17.

The method 1700 begins at start operation 1702. At step 1704, a charging station 1240 is charging a vehicle 100, as described in method 1600. At step 1708, the charging station 1240 and/or scheduler 1230 determine that the cost of power unexpectedly increased based on updated power provider attributes and/or changes in power consumption of the home power grid 1270.

At step 1712, the scheduler 1230 determines an updated charging schedule 1440 based on the power provider attributes and/or changes in power consumption of the home power grid 1270. The scheduler 1230 transmits the new charging schedule 1440 to the charging station 1240.

At step 1716, the scheduler optionally notifies one or more users of the updated charging schedule 1440 and provides a user the opportunity to confirm the charging schedule 1440. In some embodiments, a user preference is defined for one or more users that determines whether a user is giving an opportunity to confirm the charging schedule 1440, to be notified of the charging schedule 1440, or not be notified of the charging schedule 1440.

At step 1720, the charging station 1240 continues to charge the vehicle 100 during one or more scheduled charging time periods as determined in the updated charging schedule 1440 generated by the scheduler 1230. After step 1720, the method 1700 ends at end operation 1724.

Any of the steps, functions, and operations discussed herein can be performed continuously and automatically.

The exemplary systems and methods of this disclosure have been described in relation to vehicle systems and electric vehicles. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, non-volatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments include a method for charging a vehicle, the method comprising: receiving, at a scheduler and over a communications network, a set of power provider attributes; reading, by the scheduler, a set of home power usage information from one or more databases; reading, by the scheduler, a set of user charging preferences from one or more databases; reading, by the scheduler, a set of user schedule information from one or more databases; reading, by the scheduler, a set of vehicle information from one or more databases; determining, by the scheduler, an amount of power required to charge a rechargeable energy storage of a vehicle to a desired state of charge (SOC) based on the set of vehicle information and the set of user schedule information; and determining, by the scheduler, one or more charging time periods to charge the rechargeable energy storage based on the set of power provider attributes, the set of home power usage information, the set of user charging preferences, the user schedule information, the set of vehicle information, and the amount of power required to charge the vehicle.

Aspects of the above method include wherein the set of power provider attributes comprise at least one attribute defining a set of values for a cost of power based on a time of day, and wherein the set of values for the cost of power based on the time of day define at least a first time of day as having a lower cost of power than at least a second time of day.

Aspects of the above method include wherein the one or more charging time periods are scheduled between the first time of day and the second time of day.

Aspects of the above method include wherein at least one of the one or more charging time periods is scheduled between the second time of day and the first time of day based on a minimum SOC.

Aspects of the above method include wherein the set of power provider attributes comprise at least one attribute defining a set of values for a cost of power based on a home power usage level, and wherein the set of values for the cost of power based on home power usage level define at least a first home power usage level as having a lower cost of power than at least a second home power usage level.

Aspects of the above method include wherein the one or more charging time periods are scheduled to prevent a home power usage level from exceeding the first home power usage level.

Aspects of the above method include wherein prior to transferring power to the vehicle during the one or more time periods, the method further comprises: confirming, by a user via a user interface, the one or more time periods to charge the rechargeable energy storage.

Aspects of the above method include wherein, based on a user defined priority preference, operation of at least one Internet of Things (IoT) device is delayed during the one or more charging time periods.

Aspects of the above method include wherein, based on a change in power provider costs, the method further comprises: updating, by the scheduler based on the change in power provider costs, the one or more charging time periods.

Aspects of the above method include further comprising: transferring, by a charging station, power to the rechargeable energy storage during the one or more charging time periods.

Embodiments include a charging system, the charging system comprising: comprising: a processor; and a non-transitory computer readable medium coupled to the processor and comprising instructions stored thereon that cause the processor to: receive, over a communications network, a set of power provider attributes; read a set of home power usage information from one or more databases; read a set of user charging preferences from one or more databases; read a set of user schedule information from one or more databases; read a set of vehicle information from one or more databases; determine an amount of power required to charge a rechargeable energy storage of a vehicle to a desired state of charge (SOC) based on the set of vehicle information and the set of user schedule information; and determine one or more charging time periods to charge the rechargeable energy storage based on the set of power provider attributes, the set of home power usage information, the set of user charging preferences, the user schedule information, the set of vehicle information, and the amount of power required to charge the vehicle.

Aspects of the above charging system include wherein the set of power provider attributes comprise at least one attribute defining a set of values for a cost of power based on a time of day, and wherein the set of values for the cost of power based on the time of day define at least a first time of day as having a lower cost of power than at least a second time of day.

Aspects of the above charging system include wherein the one or more charging time periods are scheduled between the first time of day and the second time of day.

Aspects of the above charging system include wherein at least one of the one or more charging time periods is scheduled between the second time of day and the first time of day based on a minimum SOC.

Aspects of the above charging system include wherein the set of power provider attributes comprise at least one attribute defining a set of values for a cost of power based on a home power usage level, wherein the set of values for the cost of power based on home power usage level define at least a first home power usage level as having a lower cost of power than at least a second home power usage level, and wherein the one or more charging time periods are scheduled to prevent a home power usage level from exceeding the first home power usage level.

Aspects of the above charging system include wherein prior to transferring power to the vehicle during the one or more time periods, the charging system further comprises: confirm, by a user via a user interface, the one or more time periods to charge the rechargeable energy storage.

Aspects of the above charging system include wherein, based on a user defined priority preference, operation of at least one Internet of Things (IoT) device is delayed during the one or more charging time periods.

Aspects of the above charging system include wherein, based on a change in power provider costs, the charging system further comprises: update, based on the change in power provider costs, the one or more charging time periods.

Embodiments include a server, the server comprising: a processor; and a non-transitory computer readable medium coupled to the processor and comprising instructions stored thereon that cause the processor to: receive, over a communications network, a set of power provider attributes; read a set of home power usage information from one or more databases; read a set of user charging preferences from one or more databases; read a set of user schedule information from one or more databases; read a set of vehicle information from one or more databases; determine an amount of power required to charge a rechargeable energy storage of a vehicle to a desired state of charge (SOC) based on the set of vehicle information and the set of user schedule information; and determine one or more charging time periods to charge the rechargeable energy storage based on the set of power provider attributes, the set of home power usage information, the set of user charging preferences, the user schedule information, the set of vehicle information, and the amount of power required to charge the vehicle.

Aspects of the above server include wherein the set of power provider attributes comprise at least one attribute defining a set of values for a cost of power based on a time of day, wherein the set of values for the cost of power based on the time of day define at least a first time of day as having a lower cost of power than at least a second time of day, and wherein the one or more charging time periods are scheduled between the first time of day and the second time of day.

Any one or more of the aspects/embodiments as substantially disclosed herein.

Any one or more of the aspects/embodiments as substantially disclosed herein optionally in combination with any one or more other aspects/embodiments as substantially disclosed herein.

One or means adapted to perform any one or more of the above aspects/embodiments as substantially disclosed herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “advanced metering infrastructure (AMI)” consists of communications hardware and software, and the associated system and data management software, that together create a two-way network between smart meters and utility business systems, enabling collection and distribution of information to customers and other parties (e.g., dynamic power pricing, power consumption reporting, etc.).

The term “electrical grid” is an interconnected network for delivering electricity from suppliers to consumers. It includes generating stations that produce electrical power, high-voltage transmission lines that carry power from distant sources to demand centers and distribution lines that connect individual customers.

The term “electric vehicle” (EV), also referred to herein as an electric drive vehicle, may use one or more electric motors or traction motors for propulsion. An electric vehicle may be powered through a collector system by electricity from off vehicle sources or may be self-contained with a battery or generator to convert fuel to electricity. An electric vehicle generally includes a rechargeable electricity storage system (RESS) (also called Full Electric Vehicles (FEV)). Power storage methods may include: chemical energy stored on the vehicle in on-board batteries (e.g., battery electric vehicle or BEV), on board kinetic energy storage (e.g., flywheels), and/or static energy (e.g., by on-board double-layer capacitors). Batteries, electric double-layer capacitors, and flywheel energy storage may be forms of rechargeable on-board electrical storage.

The term “hybrid electric vehicle” refers to a vehicle that may combine a conventional (usually fossil fuel-powered) powertrain with some form of electric propulsion. Most hybrid electric vehicles combine a conventional internal combustion engine (ICE) propulsion system with an electric propulsion system (hybrid vehicle drivetrain). In parallel hybrids, the ICE and the electric motor are both connected to the mechanical transmission and can simultaneously transmit power to drive the wheels, usually through a conventional transmission. In series hybrids, only the electric motor drives the drivetrain, and a smaller ICE works as a generator to power the electric motor or to recharge the batteries. Power-split hybrids combine series and parallel characteristics. A full hybrid, sometimes also called a strong hybrid, is a vehicle that can run on just the engine, just the batteries, or a combination of both. A mid hybrid is a vehicle that cannot be driven solely on its electric motor, because the electric motor does not have enough power to propel the vehicle on its own.

The term “mains electricity” and variations thereof, as used herein, refer to the general-purpose alternating-current (AC) electric power supply. In the United States, mains electric power is referred to by several names including household power, household electricity, house current, powerline, domestic power, wall power, line power, AC power, city power, street power, and grid power.

The term “rechargeable electric vehicle” or “REV” refers to a vehicle with on board rechargeable energy storage, including electric vehicles and hybrid electric vehicles.

The term “smart grid” refers to an electrical grid which includes a variety of operational and energy measures, including one or more smart meters, smart appliances, renewable energy resources, and energy efficiency resources. Electronic power conditioning and control of the production and distribution of electricity can be important aspects of the smart grid. A common element to most definitions is the application of digital processing and communications to the power grid, making data flow and information management central to the smart grid.

The term “smart meter” is usually an electronic device that records consumption of electric energy in intervals of an hour or less and communicates that information at least daily back to the utility for monitoring and billing.

What is claimed is:

1. A method for charging a vehicle, the method comprising:
receiving, at a scheduler and over a communications network, a set of power provider attributes;
reading, by the scheduler, a set of user charging preferences from one or more databases;
reading, by the scheduler, a set of user schedule information from one or more databases;
reading, by the scheduler, a set of vehicle information from one or more databases;
determining, by the scheduler, an amount of power required to charge a rechargeable energy storage of a vehicle to a desired state of charge (SOC) based on the set of vehicle information and the set of user schedule information; and
determining, by the scheduler, one or more charging time periods to charge the rechargeable energy storage based on the set of power provider attributes, the set of home power usage information, the set of user charging preferences, the user schedule information, the set of vehicle information, and the amount of power required to charge the vehicle.

2. The method of claim 1, wherein the set of power provider attributes comprise at least one attribute defining a set of values for a cost of power based on a time of day, and wherein the set of values for the cost of power based on the time of day define at least a first time of day as having a lower cost of power than at least a second time of day and further comprising reading, by the scheduler, a set of home power usage information from one or more databases, wherein the one or more charging time periods to charge the rechargeable energy storage is further based on the set of home power usage information.

3. The method of claim 2, wherein the one or more charging time periods are scheduled between the first time of day and the second time of day.

4. The method of claim 2, wherein at least one of the one or more charging time periods is scheduled between the second time of day and the first time of day based on a minimum SOC.

5. The method of claim 2, wherein the set of power provider attributes comprise at least one attribute defining a set of values for a cost of power based on a home power usage level, and wherein the set of values for the cost of power based on home power usage level define at least a first home power usage level as having a lower cost of power than at least a second home power usage level.

6. The method of claim 5, wherein the one or more charging time periods are scheduled to prevent a home power usage level from exceeding the first home power usage level.

7. The method of claim 1, wherein prior to transferring power to the vehicle during the one or more time periods, the method further comprises:
confirming, by a user via a user interface, the one or more time periods to charge the rechargeable energy storage.

8. The method of claim 1, wherein, based on a user defined priority preference, operation of at least one Internet of Things (IoT) device is delayed during the one or more charging time periods.

9. The method of claim 1, wherein, based on a change in power provider costs, the method further comprises:
updating, by the scheduler based on the change in power provider costs, the one or more charging time periods.

10. The method of claim 1, further comprising:
transferring, by a charging station, power to the rechargeable energy storage during the one or more charging time periods.

11. A charging system, comprising:
a processor; and
a non-transitory computer readable medium coupled to the processor and comprising instructions stored thereon that cause the processor to:
receive, over a communications network, a set of power provider attributes;
read a set of user charging preferences from one or more databases;
read a set of user schedule information from one or more databases;
read a set of vehicle information from one or more databases;
determine an amount of power required to charge a rechargeable energy storage of a vehicle to a desired state of charge (SOC) based on the set of vehicle information and the set of user schedule information; and
determine one or more charging time periods to charge the rechargeable energy storage based on the set of power provider attributes, the set of home power usage information, the set of user charging preferences, the user schedule information, the set of vehicle information, and the amount of power required to charge the vehicle.

12. The charging system of claim 11, wherein the processor reads a set of home power usage information from one or more databases, wherein the processor determines the one or more charging time periods to charge the rechargeable energy storage further based on the set of home power usage information, wherein the set of power provider attributes comprise at least one attribute defining a set of values for a cost of power based on a time of day, and wherein the set of values for the cost of power based on the time of day define at least a first time of day as having a lower cost of power than at least a second time of day.

13. The charging system of claim 12, wherein the one or more charging time periods are scheduled between the first time of day and the second time of day.

14. The charging system of claim 12, wherein at least one of the one or more charging time periods is scheduled between the second time of day and the first time of day based on a minimum SOC.

15. The charging system of claim 12, wherein the set of power provider attributes comprise at least one attribute defining a set of values for a cost of power based on a home power usage level, wherein the set of values for the cost of power based on home power usage level define at least a first home power usage level as having a lower cost of power than at least a second home power usage level, and wherein the one or more charging time periods are scheduled to prevent a home power usage level from exceeding the first home power usage level.

16. The charging system of claim 11, wherein prior to transferring power to the vehicle during the one or more time periods, the charging system further comprises:
confirm, by a user via a user interface, the one or more time periods to charge the rechargeable energy storage.

17. The charging system of claim 11, wherein, based on a user defined priority preference, operation of at least one Internet of Things (IoT) device is delayed during the one or more charging time periods.

18. The charging system of claim 11, wherein, based on a change in power provider costs, the charging system further comprises:
update, based on the change in power provider costs, the one or more charging time periods.

19. A server, comprising:
a processor; and
a non-transitory computer readable medium coupled to the processor and comprising instructions stored thereon that cause the processor to:
receive, over a communications network, a set of power provider attributes;
read a set of home power usage information from one or more databases;
read a set of user charging preferences from one or more databases;
read a set of user schedule information from one or more databases;
read a set of vehicle information from one or more databases;
determine an amount of power required to charge a rechargeable energy storage of a vehicle to a desired state of charge (SOC) based on the set of vehicle information and the set of user schedule information; and
determine one or more charging time periods to charge the rechargeable energy storage based on the set of power provider attributes, the set of home power usage information, the set of user charging preferences, the user schedule information, the set of vehicle information, and the amount of power required to charge the vehicle.

20. The server of claim 19, wherein the set of power provider attributes comprise at least one attribute defining a set of values for a cost of power based on a time of day, wherein the set of values for the cost of power based on the time of day define at least a first time of day as having a lower cost of power than at least a second time of day, and wherein the one or more charging time periods are scheduled between the first time of day and the second time of day.
